(19) United States
(12) Patent Application Publication
(10) Pub. No.: US 2010/0072362 A1
(43) Pub. Date: Mar. 25, 2010

(54) TIME-OF-FLIGHT MASS SPECTROMETER AND A METHOD OF ANALYSING IONS IN A TIME-OF-FLIGHT MASS SPECTROMETER

(76) Inventors: Roger Giles, Holmfirth (GB); Michael Sudakov, St. Petersburg (RU); Hermann Wollnik, Santa Fe, NM (US)

Correspondence Address: STITES & HARBISON PLLC, 1199 NORTH FAIRFAX STREET, SUITE 900, ALEXANDRIA, VA, 22314, US

(21) Appl. No.: 12/518,236

(22) PCT Filed: Dec. 7, 2007
(86) PCT No.: PCT/GB07/04689

§ 371 Date: Dec. 2, 2009

(30) Foreign Application Priority Data
Dec. 11, 2006 (GB) 0624679.7

(51) Int. Cl. H01J 49/40; H01J 3/40

(52) U.S. Cl. 250/287; 250/489

(57) ABSTRACT

A time-of-flight mass spectrometer (1) comprises an ion source a segmented linear ion device (10) for receiving sample ions supplied by the ion source and a time-of-flight mass analyser for analysing ions ejected from the segmented device. A trapping voltage is applied to the segmented device to trap ions initially into a group of two or more adjacent segments and subsequently to trap them in a region of the segmented device shorter than the group of segments. The trapping voltage may also be effective to provide a uniform trapping field along the length of the device (10).

### FIELD OF THE INVENTION

This invention relates to a time-of-flight (ToF) mass spectrometer and a method of analysing ions in a ToF mass spectrometer, In particular, the invention relates to a ToF mass spectrometer having a segmented linear ion storage device.

ToF mass spectrometers, including quadrupole mass filter-ToF mass spectrometers and quadrupole ion trap ToF mass spectrometers are now commonly employed in the field of mass spectrometry. Commercially available ToF instruments offer resolving power of up to ˜20 k and a maximum mass accuracy of 3 to 5 ppm. By comparison, FTICR (Fourier Transform Ion Cyclotron Resonance) instruments can achieve a much higher resolving power of at least 100 k. The primary advantage of such high resolution is improved accuracy of mass measurement. This is necessary to confidently identify the analysed compounds.

However, despite their very high resolving power, FTICR instruments have a number of disadvantages in comparison to ToF instruments. Firstly, the number of spectra that can be recorded per second is low, and secondly at least 100 ions are necessary to register a spectral peak of reasonable intensity. These two disadvantages mean that the limit of detection is compromised. A third disadvantage of FTICR instruments is that a superconducting magnet is required. This means that the instrument is bulky, and has associated high purchase costs and high running costs. Therefore, there is a strong incentive to improve the resolving power offered by ToF mass spectrometers.

High resolving power during the isolation of precursor ions is important for the generation of isotopically pure MS/MS daughter ion spectra, and for the elimination of isobaric interference ions. A low detection limit is important, in the field of proteomics for example, to allow for the detection of weakly expressed protein(s) in the presence of more abundant proteins, and in many other applications areas for detecting samples at low concentration.

The capability to produce a large number of spectra per second is needed when samples are provided by Liquid Chromatography (LC) where the individually separated compounds are delivered to the mass spectrometer in short bursts or bunches lasting only a few seconds. To obtain maximum information about each compound as it elutes from the LC column, it is necessary to generate high quality spectra at a high rate. In the case where samples are directly infused without chromotographic separation, it is also useful to have the capability to generate a high number of spectra to reduce the overall analysis time, providing improved productivity.

It is desirable to achieve a high dynamic range within each acquired spectrum, so that the spectrum provides high fidelity data (good statistics and high signal-to-noise ratio), making it unnecessary to accumulate equivalent spectra. Avoiding the need for such accumulation is equivalent to increasing the effective repetition rate, and again enhances productivity.

A large mass range, (the ratio between the highest and lowest detectable masses) is also advantageous for the following reasons:

To achieve highest mass accuracy it is necessary for the spectra to contain at least one internal calibration peak. A large mass range enables the unknown peaks to lie within a corresponding wider mass range without the need for a custom calibrant for each analyte.

A second advantage of a ‘single shot’ wide mass range capability is in the MS/MS analysis of peptides; peptide ions fragment such that only the bonds between adjacent amino acids in the peptide chain are broken. A series of peaks are generated which enable the amino acid sequence of the peptide to be identified. These peaks may have a wide distribution of m/z values, and as the probability of a unique identification of the protein is dependent upon the number of detected peaks it is advantageous to have a wide mass range available.

The basic behaviour of ions in an ion trap can be described by the Mathieu parameters a and q. If the Mathieu parameter q is <0.4 then the ion motion can be viewed as secular motion within a harmonic ‘pseudopotential well’ whose depth is proportional to the product of the amplitude of the trapping waveform and the Mathieu parameter q. If a buffer gas is present in the ion trap then after a short cooling period the trapped ions will lose their kinetic energy to the buffer gas and come to reside at the centre of the pseudopotential well (in the region of lowest potential).

This localisation due to cooling results in an ion cloud occupying a reduced area in “velocity-position” phase space. More specifically, the ion cloud has reduced physical size and reduced velocity spread in directions transverse to the longitudinal axis of the ion trap. Thus, the ion cloud has a reduced emittance when it is ejected from the ion trap, and this can be of benefit to the performance of an associated ToF analyser. In particular, the root mean squared velocity (RMSV) vₜₕ(M) of an equilibrated ion cloud consisting of ions of mass M is given by the expression:

$${v}_{th} ( M ) := \sqrt{\frac{{K}_{b} \cdot T}{M \cdot {m}_{o}}} , \qquad ( 1 )$$

where K_{b} is Boltzman constant, mₒ is the unit mass and the temperature T of the ion cloud is determined by the temperature of the buffer gas, and ‘Turn around time’, ΔT_{turn around} of ions ejected from the ion trap is related to RMSV by the expression.

$$Δ {T}_{turn\_around} := \frac{2 M}{{E}_{o} \cdot γ} {v}_{th} ( M ) , \qquad ( 2 )$$

when γ is the ratio of the unit mass value to unit change value and is 9.97997×10⁷.

Thus an ion cloud having a reduced RMSV, will also have a reduced ΔT_{turn around} and this results in improved resolving power, because ΔTₜᵤᵣₙ_{_{—}}_{around} sets a limit for the mass resolving power of most types of ToF analysers.

More specifically, the resolving power of a ToF analyser is given by the expression:

$${R}_{m} = \frac{1}{2} \frac{{T}_{f}}{Δ T} , \qquad ( 3 )$$

where T_{f} is the time-of-flight and ΔT is the full width at half maximum height (FWHM) of a peak associated with a single mass-to-charge ratio in the ToF spectrum.

ΔTₜᵤᵣₙ_{_{—}}_{around} contributes to the overall value of ΔT according to the following expression:

$$Δ T = \sqrt{\begin{matrix}Δ {T}_{detector}^{2} + Δ {T}_{turn \text{-} around}^{2} + Δ {T}_{t\_jitter}^{2} + \\ Δ {T}_{chro\_ab}^{2} + Δ {T}_{sph\_ab}^{2}\end{matrix}} \qquad ( 4 )$$

It is generally the case that ΔTₜᵤᵣₙ_{_{—}}_{around} is of a similar value to ΔT_{detector}, ΔTₜ_{_{—}}ⱼᵢₜₜₑᵣ, ΔT_{chro—}ab and ΔTₛₚₕ_{_{—}}_{ab}, and so even a modest reduction in ΔTₜᵤᵣₙ_{_{—}}_{around} due to a reduction in the RMSV can provide some improvement in the resolving power.

Also, because the ion cloud has a reduced physical size in the transverse extraction direction, ions will have a reduced energy spread (and so a reduced ΔT_{chro}_{_{—}}_{ab}) when they are ejected from the ion trap by application of an extraction voltage, and this also results in improving resolving power.

Generally, it is difficult to terminate a trapping field, when it is produced by a high Q resonant LC circuit. As a result the ion cloud is afforded too much time to expand prior to the application of the extraction field. A method to overcome these problems was described in WO 2005/083742. This describes providing the trapping field by using a number of fast electronic switches, thus allowing the trapping field to be terminated with a high degree of precision relative to the phase of the trapping waveform and then after a small predetermined delay, switching to a state in which all ions move from the ion trap towards the time-of-flight mass spectrometer.

A problem associated with conventional 3D ion traps is that they have low charge capacity. This is because the quadrupole field associated with a 3D Ion Trap compresses ions towards a single point in space, and so the ion cloud will occupy a small volume centred around this point. This limited charge capacity compromises the ‘dynamic range’ and the ion throughput of the device. When the dynamic range is low, the number of ions in each mass spectrum will be limited and so a number of individual spectra might need to be accumulated over an extended time to achieve good fidelity. This accumulation process increases the analysis time as well as limiting the ability to follow fast chromatography.

A further disadvantage associated with low dynamic range is that the mass accuracy that can be attained from the ToF analyser may be compromised. To attain the highest mass accuracy each mass spectrum should contain internal calibration peaks, these peaks of known m/z value can be used to correct for small shifts in the mass axis due to, for example, short term drift and instability in the power supplies. This method of calibration only yields successful results if the peaks within a single spectrum are of sufficient intensity to precisely determine the peak position.

When considering the charge capacity of an ion trap resulting from a particular field configuration, the concept of ‘critical charge’ is useful. The critical charge of a classical 3D ion trap can be expressed as:

$${Q}_{crit\_ 3 d} := \frac{( K \cdot T \cdot 8 π \cdot {ɛ}_{o} ) \cdot {σ}_{z}}{{q}^{2}} \qquad ( 5 )$$

K is Boltzman constant, T, is temperature εₒ is the permittivity, and q is unit charge. The term σ_{z} provides a measure of the radius of the ion cloud in the z dimension, this is half the value of σᵣ, the radius of the cloud in the radial dimension. Q_{crit}_{_{—}}_{3d} represents the quantity of charge that can be loaded into the ion trap before the onset of space charge effects. When the loaded charge, Q, exceeds the critical charge, Q_{crit}_{_{—}}_{3d}, ions start to experience an interaction potential due to the presence of the other ions in the ion cloud (space charge effects) in addition to the applied quadrupole field. When the ion trap is operated above the critical charge density, the size of the equilibrated ion cloud is dictated by the space charge rather than the temperature of the ion cloud. Additionally, the critical charge marks the onset of ion stratification phenomena.

It should be noted that the critical charge is much lower than the maximum storage charge capacity of the device. In the case of the classical 3D ion trap, Q_{crit}_{_{—}}_{3d} is dependent upon the size of the ion cloud, which is determined by q. In an IT-ToF instrument all m/z values of interest must remain within certain limits defined by the size of the exit aperture through which the ion cloud must pass to get to the ToF analyser. The trapping conditions that must be employed are determined by the upper m/z value one wishes to observe in the mass spectrum.

The corresponding critical charge for a two dimensional quadrupole field is given by:

$${Q}_{crit\_ 2 d} := \frac{K \cdot T \cdot ( 2 π \cdot {ɛ}_{o} \cdot L )}{{q}^{2}} \qquad ( 6 )$$

Unlike Q_{crit}_{_{—}}_{3d}, Q_{crit}_{_{—}}_{2d} is independent of the cloud size parameters σₓ and σ_{y}, and is therefore independent of the ions m/z value.

Another difference is that Q_{crit}_{_{—}}_{2d} can be increased by increasing the length of the ion cloud in the z direction (L). However, in practice L is limited by the Z dimension emittance that can be accepted by the ToF analyzer, known as the ‘acceptance’. A practical limit is L≈10 mm. In this case the critical charge can be calculated, using the above equations to be ˜25 times greater for the 2D quadrupole field case (assuming similar dimensions of exit apertures and trapping conditions). Thus the 2D quadrupole field provides the possibility for a large increase in the dynamic range and ion throughput, in comparison to a 3D quadrupole field.

A 2D quadrupole field has several other advantages as an ion source for a ToF compared to a 3D quadrupole field. Ions can be introduced into the 2D quadrupole trapping field with much increased efficiency compared to a 3D quadrupole field over a wide mass range. Ions may be efficiently introduced along the axis which coincides with the minimum of the psuedopotential well. However, the emittance that is obtained from an axially extending ion cloud, that is cooled within a 2D quadrupole field is larger than will be accepted by some types of ToF analyzer.

Known LIT-ToF systems have a mechanism for ion loss during ion introduction, (see for example U.S. Pat. No. 5,763,878). A significant number of ions may be lost in the fringe field region between the 2D quadrupole field and the preceding and proceeding ion optical transport devices/elements. The efficiency of ion transfer into the device will depend on the form of the fringe field and the mass range of the ions to be analysed.

The 3D ion trap —ToF instrument has a maximum acquision rate in an MS mode of ˜10 spectra per second, and in an MS/MS mode of ˜5 spectra per second. By comparison the LIT-ToF apparatus as described in U.S. Pat. No. 5,763,878 suggests that an acquisition rate of 10000 spectra per second is possible. However at such a rate, the advantages afforded by using a linear ion trap can not be realized as the trapped ions are not given sufficient time to cool. In addition a high proportion of the trapped ions will also be lost. Furthermore, such high acquisition rate is unnecessary in most applications and the ion throughput suggested is higher than can actually be provided by most ion sources. A 10 mm long ion cloud in a LIT can deliver ˜10⁵ ions to the ToF analyzer. At an acquisition rate of 10⁴ spectra/second a total current of 10⁹ ions second is transported into the ToF analyzer, and this high current is equivalent to a continuous current of 160 pAmps and represents the saturation current that can be delivered by an electrospray ion source. To cool ions sufficiently to ensure that optimum performance is obtained from the ToF analyzer, a maximum rate of analysis of 100 spectra per second is more reasonable, and this is adequate for most purposes.

When performing MS/MS analysis within a 3D an ion trap, each stage of MS analysis is done sequentially. This is known as ‘tandem in time’ analysis. For each stage of MS/MS analysis it is necessary to carry out the following steps cooling, isolation, cooling, excitation, cooling. These processes are time consuming. The total time taken will depend on the resolution required in the isolation step, but typically the overall cycle time is ˜200 ms. This imposes limits of ˜5 MS² spectra per second or 2 MS³ spectra per second. The low acquisition rate is compounded by the limitation of the charge capacity of the 3D ion trap. The isolation limit for a 3D ion trap is ˜10000 ions depending on how the ions are distributed in m/z. However, the ions of interest that will remain after the isolation step may be typically ˜5% of the initial number. Thus, in a typical MS² experiment the ion throughput is typically only 2500 ions per second, and in a typical MS³ experiment the ion throughput will be as low as 50 ions per second. Therefore there is a requirement for ion-trap ToF instruments to have improved ion throughput rates and spectrum acquisition rates, particularly for MS² and MS³ analysis modes.

According to the invention there is provided a time-of-flight mass spectrometer comprising: an ion source for supplying sample ions; a segmented linear ion storage device having a longitudinal axis for receiving sample ions supplied by the ion source; voltage supply means for supplying to the device: (i) a trapping voltage which, with the assistance of cooling gas, is effective to trap sample ions, or ions derived from said sample ions in an axially-extending region of said device, said axially-extending region comprising a trapping volume of a group of two or more mutually adjacent segments of said device and to cause ions trapped in said axially-extending region subsequently to become trapped in an extraction region of said axially-extending region to form an ion cloud, said extraction region being shorter than said axially extending region, and (ii) an extraction voltage for causing ejection of the ion cloud from said extraction region in an extraction direction orthogonal to said longitudinal axis of said device, and a time-of-flight mass analyser for performing mass analysis of ions ejected from said extraction region.

In a preferred embodiment of the invention said extraction region comprises the trapping volume of one single segment of said group of segments.

Preferably, the voltage supply means is arranged to supply an RF trapping voltage to said device to create a quadrupole trapping field which is substantially uniform along and between adjacent segments of the device, to enable ions to pass between adjacent segments without substantial loss of ions.

Further preferably, adjacent segments of said segmented device have substantially the same radial dimension.

In a preferred embodiment, the spectrometer comprises ion cloud treatment means for reducing the physical size of and/or velocity spread of ions in the ion cloud, in directions transverse to the longitudinal axis before said extraction voltage is applied. This has the effect of reducing the emittance of the ion cloud when it is ejected from the extraction region. The ion cloud treatment means may be arranged to increase the trapping voltage applied to an extraction segment (so called “burst compression”) and/or to impose a delay between termination of said trapping voltage and application of said extraction voltage.

In preferred embodiments, further segments of the device may act as storage segments and/or fragmentation segments and/or filtering segments.

According to the invention there is also provided a method of analysing ions using a time-of-flight mass spectrometer comprising the steps of receiving sample ions to be analysed in a segmented linear ion storage device having a longitudinal axis; applying trapping voltage to said device, which, with the assistance of cooling gas, is effective to trap sample ions, or ions derived from sample ions in an axially-extending region of said device, said axially extending region comprising a trapping volume of a group of two or more mutually adjacent segments of said device and to cause ions trapped in said region subsequently to become trapped in an extraction region of said axially-extending region to form an ion cloud, said extraction region being shorter than said axially-extending region; applying an extraction voltage to the device, to cause ejection of said ion cloud from said extraction region in an extraction direction orthogonal to said longitudinal axis of said device; and analysing said ejected ions using a time-of-flight mass analyser.

In a preferred embodiment the method includes the step of supplying an RF trapping voltage to said device to create a quadrupole trapping field which is substantially uniform along and between adjacent segments of said device, to enable ions to pass between adjacent segments without substantial loss. Preferably, the quadrupole trapping field is substantially uniform along with entire length of the device.

According to the invention there is further provided a time-of-flight mass spectrometer comprising: an ion source for supplying sample ions: a segmented linear multipole ion device having a longitudinal axis for receiving sample ions supplied by the ion source; voltage supply means for supplying to the device;

(i) an RF trapping voltage to create a multipole trapping field which is substantially uniform along and between adjacent segments of said device, to enable ions to pass between adjacent segments without substantial loss of ions.

(ii) a DC trapping voltage, which, with the assistance of cooling gas, is effective to trap sample ions, or ions derived from sample ions in an extraction region of said device to form an ion cloud, and

(iii) an extraction voltage for causing ejection of the ion cloud from said extraction region in an extraction direction orthogonal to said longitudinal axis of said device, and a time-of-flight mass analyser for performing mass analysis of ions ejected from said extraction region.

According to the invention there is also further provided a method of operating a time-of-flight mass spectrometer comprising the steps of: receiving sample ions in a segmented linear multipole ion storage device having a longitudinal axis; applying an RF trapping voltage effective to create a multipole trapping field which is substantially uniform along and between adjacent segments of said device, to enable ions to pass between adjacent segments without substantially ion loss;

applying a DC trapping voltage, which, with the assistance of cooling gas is effective to trap sample ions, or ions derived from sample ion in an extraction region of said device to form an ion cloud, and

applying extraction voltage for causing ejection of said ion cloud from said extraction region in an extraction direction orthogonal to said longitudinal axis of said device, and analysing ejected ions using a time-of-flight mass analyser.

According to the invention there is further provided a time-of-flight mass spectrometer comprising, an ion source for supplying sample ions, a segmented linear ion storage device having a longitudinal axis for receiving sample ions supplied by the ion source, voltage supply means for supplying RF multipole trapping voltage to the device, for selectively supplying DC voltage to segments of the device to cause sample ions, or ions derived from sample ions to move between different axially-extending regions of the device where ions selectively undergo MS processing, and for causing processed ions to become trapped in the trapping volume of an extraction segment of the device, and for supplying an extraction voltage to the extraction segment to ejected trapped ions in an extraction direction, orthogonal to said longitudinal axis of the device, and a time-of-flight analyser for performing mass analysis of ions ejected from the extraction segment.

### BRIEF DESCRIPTION OF THE DRAWINGS

Embodiments of the invention are now described, by way of example only, with reference to the accompanying drawings in which;

FIG. 1 shows a cross-sectional view of a ToF mass spectrometer of a preferred embodiment of the invention;

FIG. 2 shows a cross-sectional view of a segmented linear ion storage device used in one embodiment of the invention;

FIG. 3 shows a cross-sectional view of a segmented linear ion storage device used in an alternative embodiment of the invention;

FIG. 4 illustrates DC bias voltage supplied to each segment of the segmented device of FIG. 2 during each stage of a complete cycle of an MS experiment, in a first mode of operation of the spectrometer;

FIG. 5 shows an arrangement using 2 pairs of digitally-controlled switches for applying a trapping waveform to the segmented device;

FIG. 6 shows an alternative switching arrangement using a single pair of switches;

FIG. 7 shows an alternative switching arrangement using 2 pairs of switches connected to the segmented device via capacitors;

FIG. 8 shows a typical RF trapping waveform applied to the segmented device;

FIG. 9 shows a typical RF trapping waveform having a DC voltage applied between the X and Y rods;

FIG. 10 shows the voltages applied to the X and Y rods of an extraction segment of the segmented device to cause ejection of ions from the extraction segment;

FIG. 11 shows a switching arrangement for applying the extraction voltage to the extraction segment of the segmented device;

FIG. 12 shows an alternative switching arrangement for applying the extraction voltage to the extraction segment of the segmented device;

FIG. 13 illustrates DC bias voltage supplied to each segment of the segmented device of FIG. 2 during each stage of a complete cycle of an MS experiment, in a second mode of operation of the apparatus;

FIG. 14 illustrates DC bias voltage supplied to each segment of the segmented device of FIG. 2 during each stage of a complete cycle of an MS experiment in a third mode of operation of the apparatus;

FIG. 15 shows an a-q diagram. The unshaded region within the boundaries corresponds to ions of a selected m/z ratio to be isolated;

FIG. 16 shows a frequency spectrum view of a broadband signal necessary to isolate the ions in the unshaded region of FIG. 15;

FIG. 17 shows a schematic trapping waveform with associated dipole signal applied to a segment of the device to cause resonance excitation at a desired q value of ions in the segment;

FIG. 18 shows a switching arrangement for applying the trapping waveform with associated dipole signal;

FIG. 19 shows a single frequency dipole superimposed upon the RF trapping waveform as applied to a segment of the device;

FIG. 20 shows a further a-q diagram used for illustrating the single frequency dipole excitation process.

FIG. 21(a) shows the trapping waveform as applied to the extraction segment during the burst compression process;

FIGS. 21(b) and 21(c) show the respective voltages applied to the X and Y rods of the extraction segment as a function of time during the burst compression process;

FIG. 22 illustrates DC bias voltage applied to each segment of the segmented device of FIG. 2 during each stage of a complete cycle of an MS/MS experiment in a fourth mode of operation of the apparatus;

FIG. 23 illustrates DC bias voltage applied to each segment of the segmented device of FIG. 2 during each stage of a complete cycle of an MS/MS experiment in a fifth mode of operation of the apparatus;

FIG. 24 shows an RF trapping waveform with DC offset applied between the X and Y rods to allow isolation/filtering of ions in a segment.

FIG. 25 shows a further a-q stability diagram used to illustrate mass selective filtering of ions;

FIG. 26 shows a trapping waveform with a modified duty cycle introducing an effective DC offset between X and Y rods;

FIG. 27 shows an a-q stability diagram with shifted boundaries reflecting the DC offset of FIG. 26;

FIG. 28 shows the waveform applied to the X and Y rods of a segment when the frequency of the RF waveform is scanned;

FIG. 29 illustrates DC bias voltage supplied to each segment of the segmented device of FIG. 3 during each stage of a complete cycle of an MS/MS experiment in a sixth mode of operation of the apparatus;

FIG. 30 illustrates DC bias voltage applied to each segment of the segmented device of FIG. 3 during each stage of a complete cycle of an MS³ experiment in a seventh mode of operation of the apparatus;

FIG. 31 is an illustration of a segment of the segmented device with hyperbolically-shaped rods;

FIGS. 32(a) and 32(b) illustrate segments of the segmented device formed using flat plate electrodes;

FIG. 33 shows an ion trap formed of circular plate electrodes with the lower electrode having an extraction slot;

FIG. 34 shows a PCB plate electrode with overlapping electrodes in linear and circular configurations, and the associated switches for activating the electrodes in a linear operating mode;

FIG. 35 shows a PCB plate electrode with overlapping electrodes in linear and circular configurations, and the associated switches for activation in circular mode.

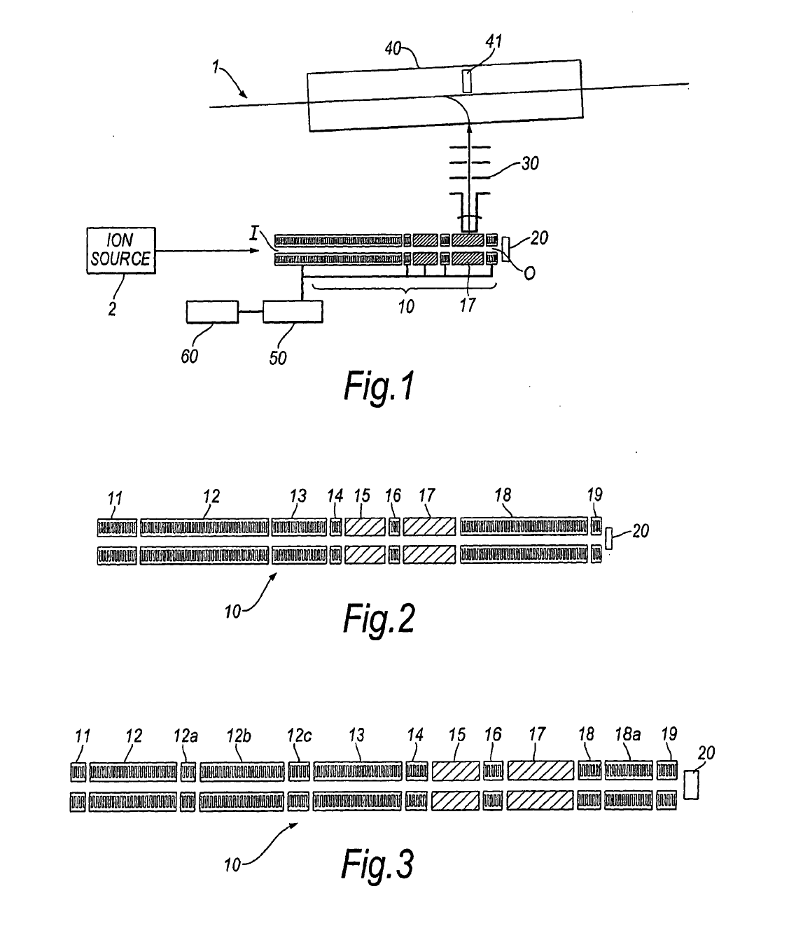

Referring now to the drawings, FIG. 1 shows a schematic overview of a ToF mass spectrometer according to an embodiment of the invention.

The spectrometer 1 comprises an ion source 2, a segmented linear ion storage device 10 having an entrance end I for receiving ions supplied by the ion source 2 and an exit end O, a detector 20 positioned adjacent the exit end O for detecting ions exiting the exit end O, a ToF mass analyser 40 having a detector 41 and ion focusing elements 30.

The spectrometer also includes a voltage supply unit 50 for supplying voltage to segments of the ion storage device 10 and a control unit 60 for controlling the voltage supply unit. In this embodiment, the ToF mass analyser 40 comprises a reflectron; however, any other suitable form of ToF analyser could a alternatively be used; for example, an analyser having a multipass configuration.

FIGS. 2 and 3 show longitudinal sectional views of different embodiments of the segmented linear ion storage device 10. The device shown in FIG. 2 has nine discrete segments 11 to 19, whereas, the device shown in FIG. 3 has thirteen discrete segments, including three additional segments 12a, 12b and 12c between segments 12 and 13 and an additional segment 18a between segments 18 and 19.

In preferred embodiments, device 10 is a quadrupole device. Alternatively, though less desirably, a different multipole device could be used, e.g. a hexapole device or an octopole device. In the embodiments which follow, it will be assumed that device 10 is a quadrupole device. In the case of a quadrupole device, each segment may comprise four poles (e.g. rods) arranged symmetrically around a common longitudinal axis, although a configuration formed from a series of flat plate electrodes could alternatively be used, as will be described in greater detail hereinafter.

In operation, voltage supply unit 50 supplies RF trapping voltage to the segments to produce a two-dimensional quadrupole trapping field within the trapping volume of the segments. In effect, the trapping field creates a pseudopotential well, with the bottom of the well being centred on the longitudinal axis. By this means, ions having a predetermined range of mass-to-charge ratio, determined by characteristics of the trapping voltage, as expressed by the aforementioned Mathieu parameters a, q, can be trapped in the radial direction, the trapping field tending to constrain ions to accumulate on or near to the longitudinal axis at the bottom of the potential well.

The voltage supply unit 50 is also arranged selectively to supply DC bias voltage to segments of the device. As will be described in greater detail hereinafter, DC voltage selectively supplied to segments may fulfil different operational functions depending on a required mode of operation.

For example, DC voltage supplied to segments can be used to create a DC potential gradient along the device causing ions to pass between segments as they move down the potential gradient. DC voltage supplied to segments can also be used to create a DC potential well within the trapping volume of a single segment or within the trapping volume of a group of two or more mutually adjacent segments.

In preferred embodiments, DC voltage supplied to segments of the device 10 creates a relatively wide DC potential well within the trapping volume of a group of two or more mutually adjacent segments. The DC potential well is arranged to be deeper within the trapping volume of one (or possibly more than one) segment of the group than within the i trapping volume of the other segments of the group. Initially, ions become trapped in a relatively wide axially-extending region of the device 10 defined by the trapping volume of the entire group of segments and as the trapped ions lose kinetic energy, due to collisions with cooling gas, they progressively sink to the bottom of the potential well and are thereby confined, in the axial direction, within a relatively narrow region of the device 10 where they form an ion cloud.

In particularly preferred embodiments, an ion cloud is formed in this manner within the trapping volume of an extraction segment of the device (segment 17 of FIG. 1) and is subsequently ejected from that segment in an extraction direction orthogonal to the longitudinal axis by application of an extraction voltage to the segment. The ejected ions are then analysed using the ToF analyser 40.

By this measure, the efficiency with which ions having a wide mass range (for example, as great as say a factor of 10 between the highest and lowest masses) are cooled within the device 10 to form an ion cloud is improved, giving increased ion throughput and improved sensitivity and dynamic range.

It has been found to be beneficial to arrange for the quadrupole trapping field to be substantially uniform along and between adjacent segments of the device 10 to enable ions within a wide mass range to pass between segments without substantial loss of ions, again giving improved dynamic range and enhanced ion throughput.

Voltage supplied by voltage supply unit 50 under the control of control unit 60, may cause a segment or a group of segments of device 10 selectively to perform one or more of a range of different operational functions including trapping, storing, isolating, fragmenting, filtering and extracting ions, as required by a particular mode of operation of the spectrometer 1.

By an appropriate selection of DC voltage, ions can be caused to move axially between different regions of the device 10 where different operational functions may be performed, and it is possible for the same segment or the same group of segments to perform different operational functions at different stages of the operation, and for different segments or groups of segments to perform different operational functions at the same time.

The segmented device 10 may be arranged so that different segments or different groups of segments are located in different vacuum chambers, maintained at different pressures and separated by aperture plates located within the gap between segments, with each segment and associated aperture having a separate voltage supply unit.

The segmented device 10 may be operated so that all segments operate at the same frequency, voltage and phase; alternatively, at least one segment may be operate at a different frequency, voltage and phase, but may be switched at any time to operate under the same conditions as the other segments.

It will be appreciated that control unit 60 may be so configured that the spectrometer has a single mode of operation; alternatively, the spectrometer may selectively operate in any one of a number of different modes of operation.

Examples of preferred modes of operation are now described.

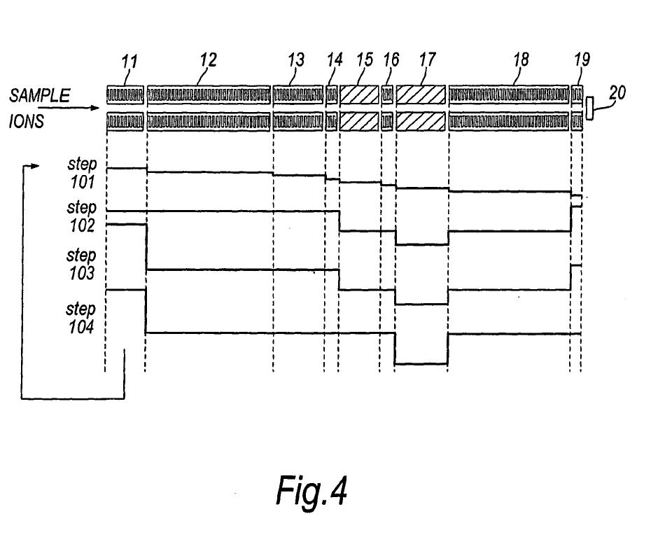

A first mode of operation of the device is now described with reference to FIG. 4. In this mode of operation the spectrometer can produce an MS spectrum with a variable duty cycle. For example, a single ToF spectrum may be produced using ions supplied to segment 11 (the entrance segment) in the form of a continuous beam.

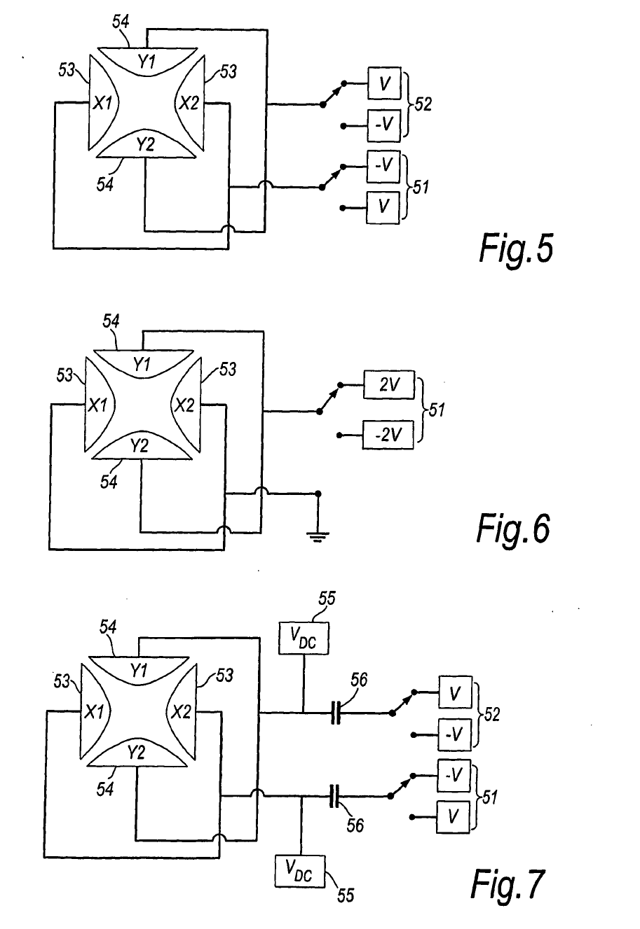

As shown in FIG. 4, in step 101 a suitable set of DC and RF trapping voltages is applied to all the segments of device 10. Precisely how the voltages are applied to the segments is described below with reference to FIGS. 5-9. The applied voltages are such as to allow ions entering through segment 11 to pass along the entire length of the device (through all segments 11-19), to pass out of segment 19 to be detected by ion detector 20. This is because the DC voltage supplied to the segments by the voltage supply unit 50 progressively decreases along the axial length of device 10, causing ions to pass between segments as they move down the potential gradient so created. The ion current detected at detector 20 over a predetermined duration is accumulated and stored in control unit 60.

The next step is step 102 which occurs after a suitable fixed duration. In this step, the RF trapping voltage is unchanged from step 101, but the DC voltages are adjusted to allow ions entering the device 10 to become initially trapped within a potential well created within segments 15-18. A cooling buffer gas (e.g. a noble gas such as He) is provided within all segments of the device 10. As the trapped ions in segments 15-18 collide with the buffer gas they lose kinetic energy, and this will cause the trapped ions to eventually accumulate at the position of lowest axial DC potential, in this case in the extraction segment 17.

After a time duration determined according to the accumulated ion current measured in step 101, the DC voltages shown in step 103 are applied to the device 10. The voltage on segment 11 is considerably higher than the voltage on all of the remaining segments and this prevents further ions entering the device 10 through segment 11. The previously accumulated ions in segments 15-18 are given additional time to collide with the buffer gas, and this ensures that the maximum number of ions are confined within the extraction segment 17. After a few milliseconds the ions in the extraction segment 17 will reach thermal equilibrium with the buffer gas.

In step 104 the DC voltages are adjusted to confine the ion cloud in segment 17 axially within a central portion of the segment, and this will reduce the emittance of the ion cloud within the segment when it is ejected from the extraction segment.

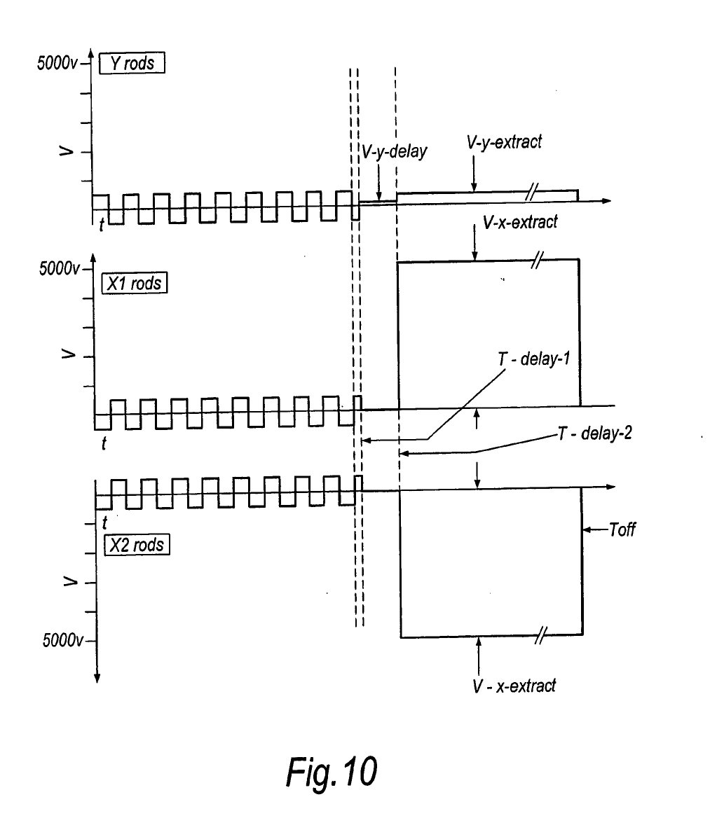

After step 104, an extraction voltage (not shown) is applied to segment 17 to extract ions from the segment 17 in an extraction direction orthogonal to the longitudinal axis of the segmented device 10, for analysis by the ToF analyser. Again, the precise application of the extraction voltage will be described shortly, with reference to FIGS. 10-12. Steps 101-104 can then be repeated, to provide further ions to be extracted from segment 17 for analysis by the ToF analyser.

This particular mode of operation prevents charge overloading of the segmented device 10, by measuring the incoming ion beam current with detector 20 and using this measurement of ion current to adjust the duty cycle of the device 10. This method is desirable because if charge overloading of device 10 occurs, ions of higher m/z ratio will be preferentially discriminated, or may even be completely lost. The duty cycle achieveable using this method depends on the duration of step 102 as compared to the overall cycle time.

In this mode of operation, when the ion beam current is high the duty cycle will be correspondingly reduced.

FIGS. 5-7 show alternative switching arrangements used to apply an RF trapping waveform to the segmented device.

In FIG. 5, the trapping waveform is applied using two pairs of digitally controlled switches 51, 52 connected to X poles 53 and Y poles 54 respectively of a quadrupole segment of device 10. This will produce an RF trapping waveform within the segment. Alternatively, the RF trapping waveform may be generated using the arrangement of FIG. 6, which has a single pair of switches 51, connected to the Y rods 54. The X rods are connected to ground.

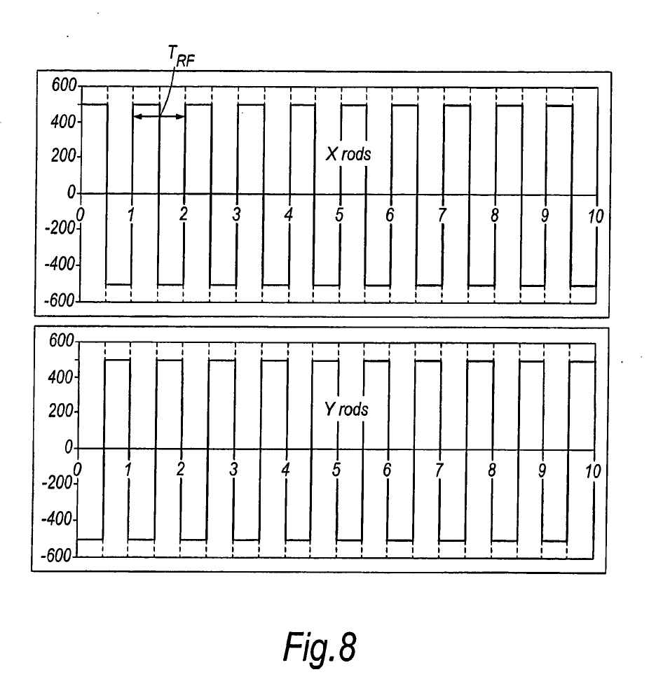

A typical RF waveform resulting from the switching arrangements show in FIG. 5 is shown in FIG. 8. This shows a square wave with a 50% duty cycle. The amplitude of the waveform, and period T_{RF} are selected according to the m/z range of ions to be trapped within the segment. As can be seen, the RF trapping waveform of FIG. 8 has no DC component with reference to ground.

Further details on the use of digitally controlled switches to produce an RF trapping waveform are provided in WO 01/29875 (Ding).

FIG. 7 shows a switching arrangement which can be used to introduce a DC offset between segments of the device 10, or between the X and Y rods within one segment of the device 10.

In this case, the switches 51, 52 are connected to the X and Y rods 53, 54 via a capacitor 56. The circuitry also includes element 55 for introducing a DC offset between the segments, or for introducing a DC offset between the X and Y rods 53, 54 within one segment of device 10.

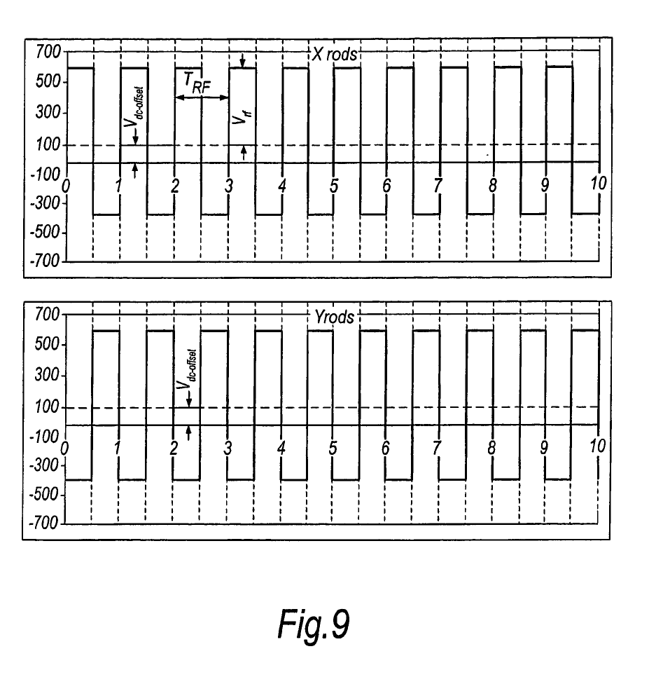

FIG. 9 shows the resulting RF trapping waveform with the applied DC offset voltage. In this example, the same voltage is applied to the X and Y rods. The DC offset may be the same or different for each of the segments in the device 10 and is set for example, to trap an ion cloud axially within a group of segments, to trap an ion cloud within one segment of the group, or to introduce an axial field to cause ions to travel from the entrance segment 11 to the exit segment 19 of the device 10.

The application of the extraction voltage to the segmented device 10 will now be described with reference to FIGS. 10-12.

FIG. 10 shows the voltages applied to the X and Y rods of the extraction segment 17 during the extraction step.

Between t=0 and t=T_{delay-1} ions are confined in segment 17 by the RF trapping waveform applied to the X and Y rods of the extraction segment 17. At time, t=T_{delay-1}, (which corresponds a particularly favourable phase of the RF cycle) the trapping voltage is terminated; the voltage on the X rods is set to zero and the voltage on the Y rods is set to V=V_{y-delay}. Between time t=T_{delay-1} and t=T_{delay-2} the rods are maintained at these voltages.

At t=T_{delay-2} the voltage on the Y rods is set to a different DC voltage; V=V_{y-extract}. Simultaneously, the extraction voltages +V_{x-extract} and −V_{x-extract} are applied to the X1 and X2 rods respectively. This causes all ions to be ejected from the extraction segment 17 through the X2 rod. At t=T_{off} the voltages on all rods are set to zero to stop the extraction.

The delay introduced between t=T_{delay-1} and t=T_{delay-2} effectively gives rise to a reduced velocity spread in directions transverse to the longitudinal axis before the extraction voltage is applied. In this case, the area occupied by the ion cloud in “velocity-position” phase space is substantially unchanged; that is, the physical size of the ion cloud in the extraction direction increases because the ion cloud is no longer constrained by the RF field, and it expands in the relatively weaker constant quadrupole field. Correspondingly, the initial phase space ellipse of the ion cloud transforms from one which is initially upright to one which is stretched and tilted, and the position and velocity of the ions are correlated. As the area of the phase space ellipse remains constant during expansion of the ion cloud, the velocity spread in the X direction must correspondingly reduce.

Intermediate voltages may be applied to the X and Y rods during the delay period to manipulate the ion cloud in the extraction segment 17 and further reduce the velocity spread in the X direction. By reducing the velocity spread in this way the overall resolving power of the spectrometer can be improved. Alternatively, different voltages may be applied during the delay period to provide spatial focusing of the extracted ion beam to be provided to the ToF analyser.

Typically, the extraction voltage is at least 5 kV with a rise time of approximately 50 ns.

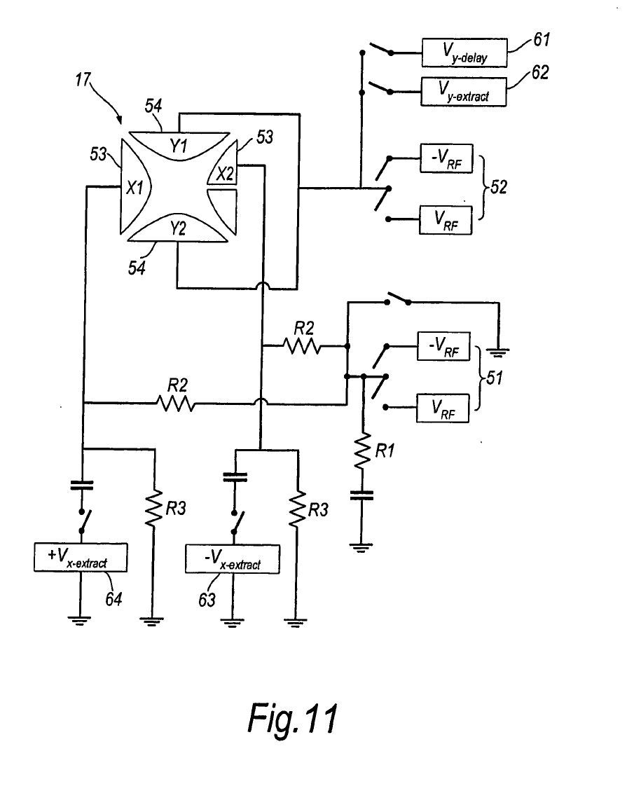

FIG. 11 shows a possible circuit for applying the extraction voltages described with reference to FIG. 10. As described with reference to FIGS. 5-7, switches 51 and 52 apply the RF trapping waveform to X rods 53 and Y rods 54 respectively. Switches 61, 62 apply the delay and extraction voltages to the Y rods and switches 63 and 64 apply the extraction voltages to rods X2 and X1 respectively.

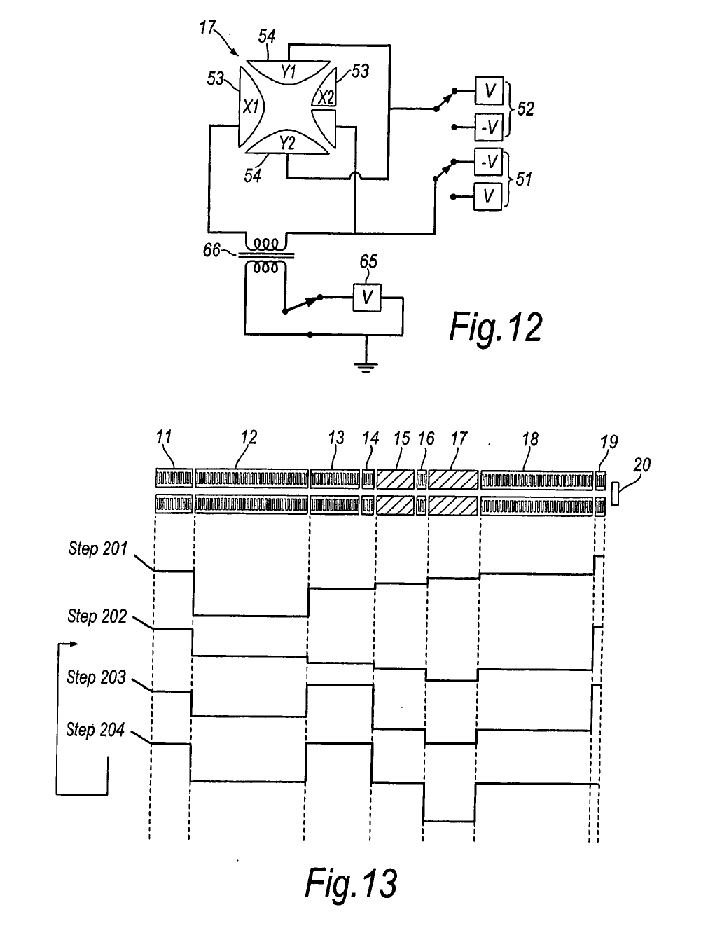

FIG. 12 shows an alternative circuit for applying an extraction voltage to extraction segment 17. This circuit uses a lower voltage switch 65 connected to a high bandwidth step-up transformer 66 to provide the extraction voltage. The secondary windings of transformer 66 are preferably wound in a bifilar configuration.

As well as applying to the above described first method these methods of applying trapping/DC voltages and the extraction voltages are also applicable to further modes of operation described hereinafter.

FIG. 13 shows a second mode of operation of the device 10. This method may achieve a 100% duty cycle.

In step 201, a suitable set of DC and RF trapping voltages are applied to all the segments of device 10. These voltages allow ions to enter device 10 through entrance segment 11 and to be initially confined within a wide DC potential well created within segments 12 to 18. As the trapped ions in segments 12-18 collide with buffer gas they lose kinetic energy, and this will cause them to accumulate at the bottom of the DC potential well, in this case in segment 12.

In step 202 the applied DC and RF voltages are adjusted. The adjusted voltages are such that the ions trapped within segment 12 in step 201 move into segments 15-18; that is to say, they move down the potential gradient created by the adjusted voltages, whilst sample ions are still able to enter the device 10 through entrance segment 11.

In step 203 the applied voltages are again adjusted. The applied voltage is effective to cause the ions transferred to segments 15-18 in step 202 to be initially trapped in these segments. As in step 201, the trapped ions collide with buffer gas and lose kinetic energy, eventually ending up in the segment with the lowest DC potential, in this case, in the extraction segment 17, where they will eventually reach thermal equilibrium with the buffer gas. Whilst these ions are being trapped in segments 15-18 and eventually segment 17, more sample ions are entering device 10 through entrance segment 11 and being trapped in segment 12.

Step 204 is similar to step 104 of FIG. 4. In this step the voltages are adjusted to confine the ion cloud within extraction segment 17 axially, within a central portion of segment 17. This step reduces the emittance of the ion cloud within the segment 17, when it is ejected from the extraction segment.

After step 204 the extraction voltage (as described above) is applied to extraction segment 17. Steps 201-204 and the extraction step are cycled through continuously.

This method of operation is particularly useful when the incident ion beam current is high, as in this case the time needed to fill the device 10 may be short compared to the overall time to complete the cycle and acquire a mass spectrum.

However, if the incoming ion beam current exceeds the maximum charge throughput capability of device 10, then the charge capacity of device 10 will be exceeded, and detrimental effects due to charge overloading will arise.

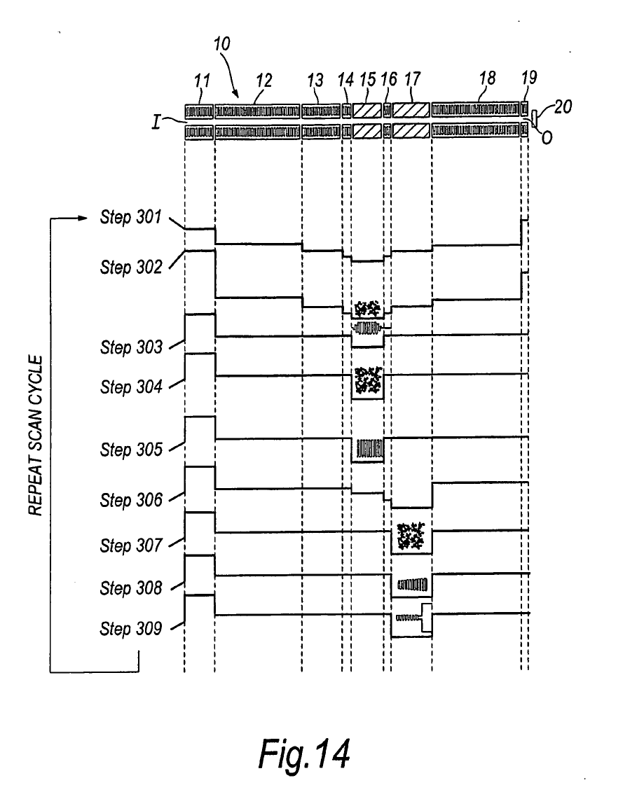

FIG. 14 shows a third mode of operation of the device 10. This method of operation uses a precursor ion isolation step to provide high resolving power, with high efficiency.

In step 301, a suitable set of DC and RF trapping voltages are applied to all segments of device 10. These voltages allow ions to enter through entrance segment 11 and to be initially trapped in segments 12-18.

In step 302, the applied voltages are such as to prevent any further ions from entering device 10 whilst allowing the ions initially trapped in segments 12-18 to collide with buffer gas and lose kinetic energy to the buffer gas. As in previous methods, this loss of kinetic energy will cause the trapped ions to accumulate at the position of lowest DC potential, in this case in segment 15. Eventually the ions trapped in segment 15 will reach thermal equilibrium with the buffer gas in the segment.

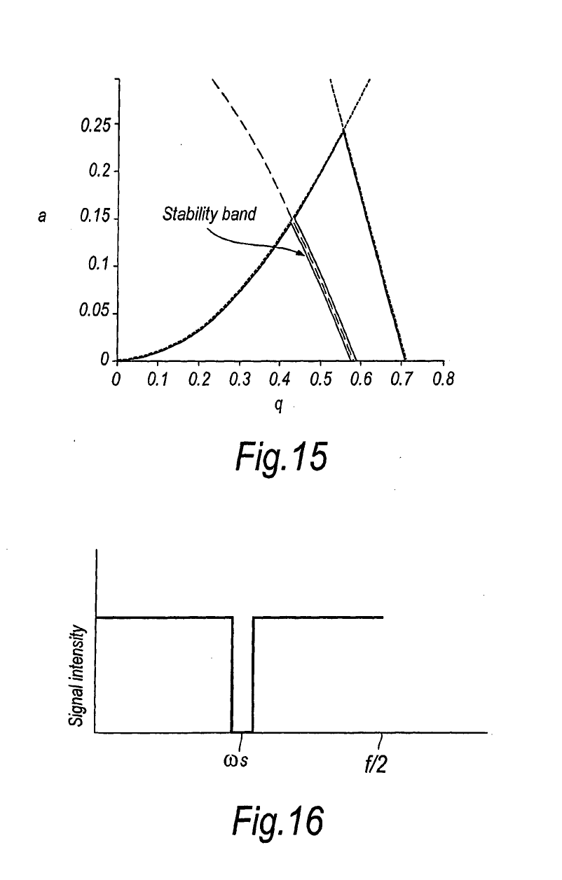

In step 303 the applied voltages are effective to isolate precursor ions of a desired n/z range in segment 15 by ejecting unwanted ions. This isolation may be carried out using broadband dipole excitation which is described in more detail more with reference to FIGS. 15 and 16 below.

In step 304 the applied voltages are effective to trap the precursor ions selected (or isolated) in step 303 in segment 15. Again, the precursor ions will collide with buffer gas to lose kinetic energy and will accumulate at the position of lowest DC potential within segment 15. As in step 302, eventually thermal equilibrium will be reached between the buffer gas and the precursor ions.

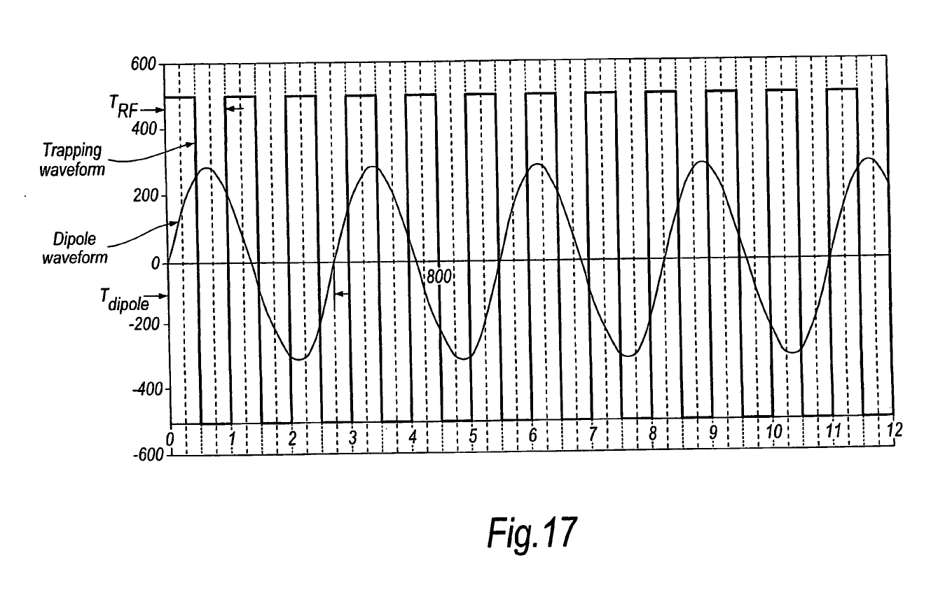

In step 305 the applied voltages are effective to fragment the cooled precursor ions in segment 15 by applying a single frequency dipole excitation to the segment, effective to cause resonant Collision Induced Dissociation (CID). The voltages necessary to cause such fragmentation will be described in detail below, with reference to FIGS. 17 to 20.

In step 306 the applied voltages are effective to cause the fragmented ions trapped in segment 15 to be transferred between segments 15-17 and to be trapped within these segments. As described with reference to other steps, the trapped ions will collide with the buffer gas. They will lose kinetic energy and will eventually accumulate at the position of lowest axial DC potential. In this case, they will accumulate in segment 17, the extraction segment.

Step 307 is similar to step 204 of FIG. 13 and step 104 of FIG. 1, the applied voltages D causing axial confinement of the ions in the extraction segment 17. This reduces the emittance of the ion cloud in segment 17.

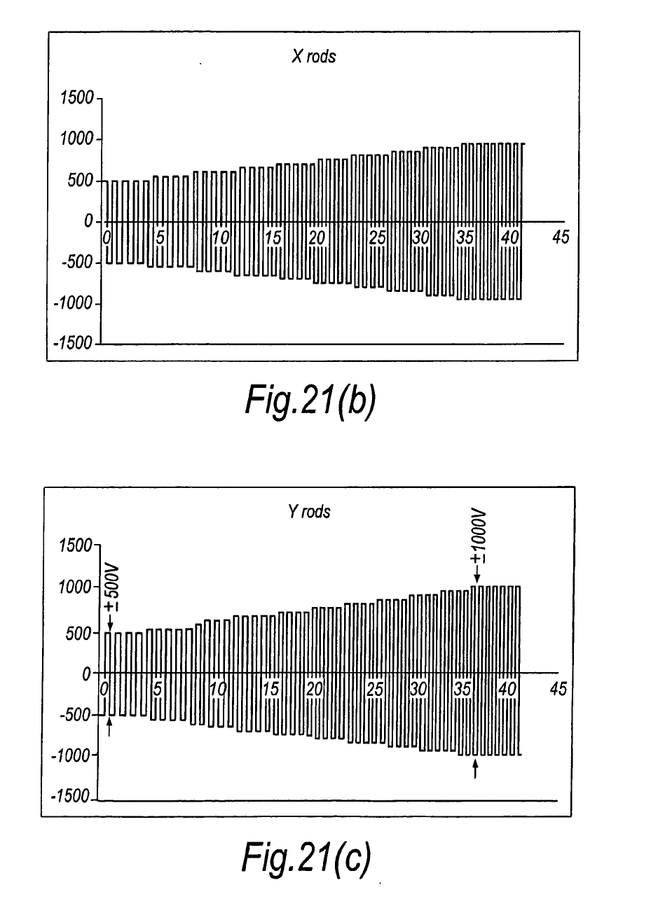

In step 308 the applied voltages are effective to compress the ion cloud in extraction segment 17 so that it occupies a reduced area in “velocity-position” phase space in directions transverse to the longitudinal axis of the ion trap. This process, referred to as “burst compression”, will be described in more detail below with reference to FIGS. 21(a)-21(c).

In step 309 an extraction voltage is applied to the extraction segment 17.

In all of steps 302-309 the voltage applied to entrance segment 11 is such as to prevent further sample ions entering the device 10 whilst the steps are being performed. Steps 301-309 can be cycled through continuously.

This method of ‘tandem in time’ analysis provides high resolving power with high efficiency. However, it is a relatively slow method and is limited to approximately 5-10 MS² spectrum/sec.

As mentioned above, a brief explanation of broadband dipole excitation is now provided.

FIG. 15 shows an a-q stability diagram. These are well known in the art. Using broadband excitation it is possible to eject all of the ions within the shaded region of the diagram, and to isolate the ions of a particular m/z ratio within the unshaded region. This unshaded region is the stability band and contains the desired precursor ions.

FIG. 16 shows the frequency spectrum of a broadband signal applied to segment 15 of device 10 to isolate the desired precursor ions. The actual signal to be applied to segment 15 can be derived from a reverse Fourier Transform of the frequency spectrum. Typically the broadband signal is applied for several milliseconds and is effective to eject unwanted ions from the segment and isolate the desired precursor ions in the segment.

FIGS. 17 to 20 are used to illustrate single frequency dipole excitation which is used to cause CID (Collision Induced Dissociation). The single frequency dipole excitation is applied to segment(s) of the device 10 to excite (or eject) ions of a particular m/z range.

FIG. 17 shows the RF trapping waveform (T_{RF}) and the dipole waveform separately as they are applied to segment(s) of device 10. The effect of the dipole waveform is to excite and/or eject ions of a particular m/z ratio within the segment to which the waveforms are applied. Preferably, the period of the dipole waveform is chosen to be an integral number of quarter waves of the RF trapping waveform. This is shown in FIG. 17, where the two waveforms have a frequency ratio of 2.75, and the waveforms come back into phase after exactly 11 cycles of RF trapping waveform and 4 cycles of the dipole waveform.

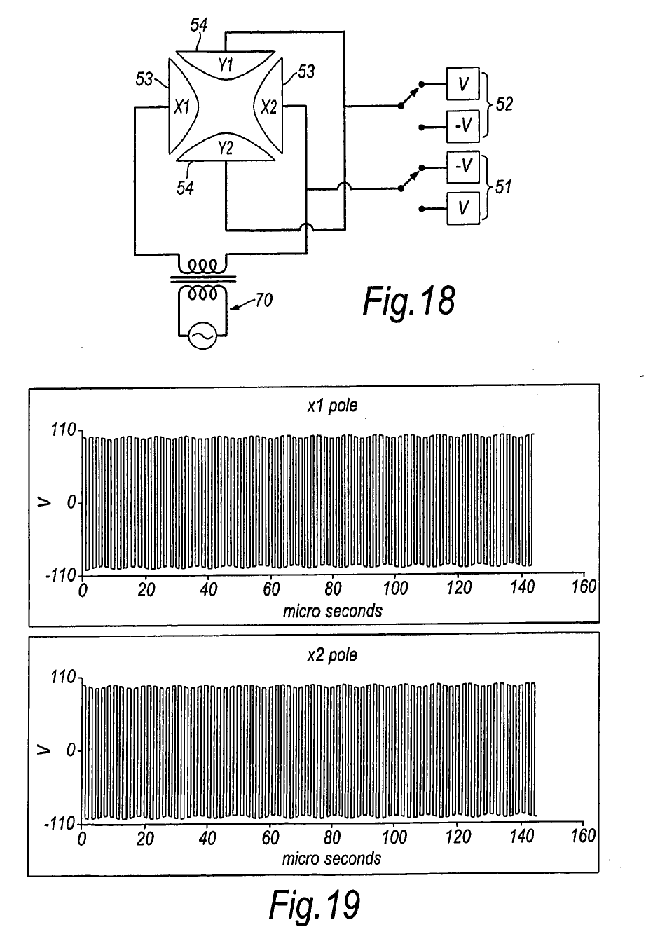

FIG. 18 illustrates a preferred digital switching arrangement showing how the RF and dipole waveforms are supplied to segment(s) of the device 10. In this example, the dipole waveform (generated by sinusoidal generator 70) and trapping waveform are superimposed and applied to the X rods 53 of the segment. Typically, this is done using an isolation transformer, with secondary windings coiled in a bi-filar configuration.

FIG. 19 shows the actual form of the superimposed voltage, (trapping waveform and dipole excitation) as it is applied to the X rods 53 of the segment waveform using the switching arrangement of FIG. 18.

The ratio between the frequency of the RF waveform and the dipole waveform determines the β value at which ions will resonate in response to the applied voltage, according to the expression:

$$β = \frac{2 {w}_{s}}{f} , \qquad ( 7 )$$

where f is the frequency of the RF waveform and wₛ is the frequency of the dipole waveform. The frequencies of the two waveforms can be scanned such that β is maintained at a constant value to scan the m/z value at which ions are excited. This will excite ions in a specific m/z range. In the third mode of operation this will be the m/z range of the precursor ions already contained in segment 15 of device 10.

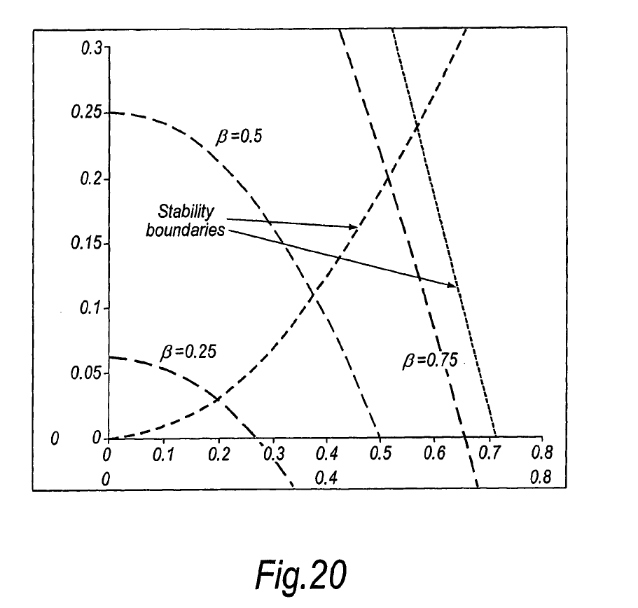

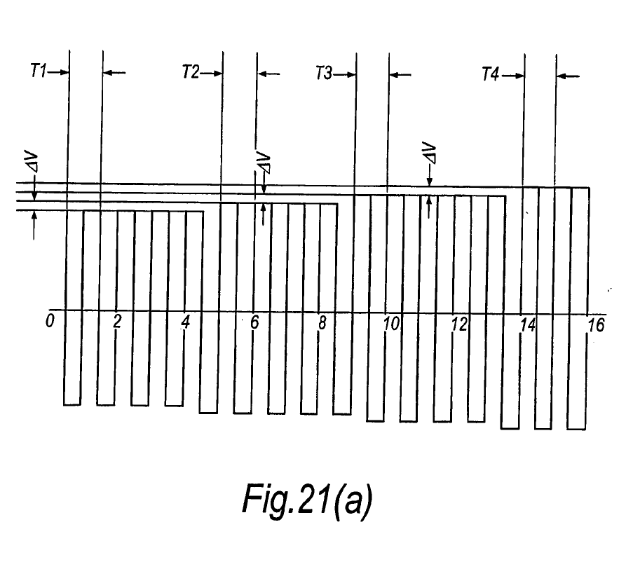

FIG. 20 shows a second a-q diagram where the stability region (contained within the dotted lines) is intersected by three different β lines; β=0.25, 0.5 and 0.75. These lines intersect the q axis at values of 0.2692, 0.5 and 0.65677 respectively. When β is maintained at a constant value (as described above) all ions in the desired m/z range will be ejected at the same value of q.

For example, using the waveforms as shown in FIG. 17, the frequency ratio is 2.75 and as the frequencies are scanned, ions of increasing m/z values will be ejected/excited with a q value of 0.64639.

An applied dipole excitation causes the precursor ions in the segment to which the signal is applied to oscillate. By controlling the amplitude, and pressure and duration of the applied dipole signal ions may be made to undergo CID without ejecting the ions from the segment.

The voltages applied to segment 17 to cause the ‘burst’ compression will now be described with reference to FIGS. 21(a)-21(c).

As shown in these Figures, the amplitude V of the digital trapping waveform voltage is momentarily increased, thereby deepening the psuedopotential well created by the trapping waveform. This has the effect of reducing the physical size of the ion cloud in directions transverse to the longitudinal axis,. including the extraction direction. More specifically, the physical size of the ion cloud is expressed as a standard deviation, σₘ given by:

$${σ}_{m} := {r}_{o} \sqrt{\frac{{K}_{B} T}{2 D}} , \qquad ( 8 )$$

where T is the ion cloud temperature, rₒ is the radial dimension of the segment and D is the amplitude of the effective trapping potential given by:

D=0.412Vqqₒ, (9)

where qₒ is the unit charge, q is the Mathieu parameter and V is the amplitude of the trapping voltage assumed to have a square waveform with a 50% duty cycle. Thus, it can be seen that σₘ, is reduced by increasing amplitude V. This reduction in σₘ gives rise to a reduced energy spread of ions in the ion cloud when the extraction voltage is applied to the extraction segment, giving a reduction of ΔT, and so improved resolving power.

Since:

$$q = \frac{4 γ V}{{mr}_{o}^{2} Ω} , \qquad ( 10 )$$

the trapping frequency Ω must be increased in proportion to \sqrt{V} to maintain a given range of mass-to-charge ratio of ions in the extraction segment 17.

As shown in the Figures, the magnitude of the trapping voltage is increased gradually in a series of steps. This prevents re-introduction of energy to a previously cooled ion cloud. As already explained, the frequency and voltage should be increased together (see ΔV and corresponding T1-T4 in FIG. 21(a)), so as to ensure that q is not changed. For example, if the voltage is increased in a series of equally sized steps then the frequency should be increased according to the square root of the increase in the voltage. Using a digital waveform it is possible to increase the magnitude of the trapping waveform in one abrupt step, with no intermediate steps. However, this approach can result in ion loss, particularly at the highest/lowest values within an m/z range. Therefore, the stepped approach described above is preferred. As already described the burst compression technique has the beneficial effect that it reduces emittance of the ion cloud when it is ejected from the extraction segment of device 10, improving the overall performance of the ToF mass spectrometer.

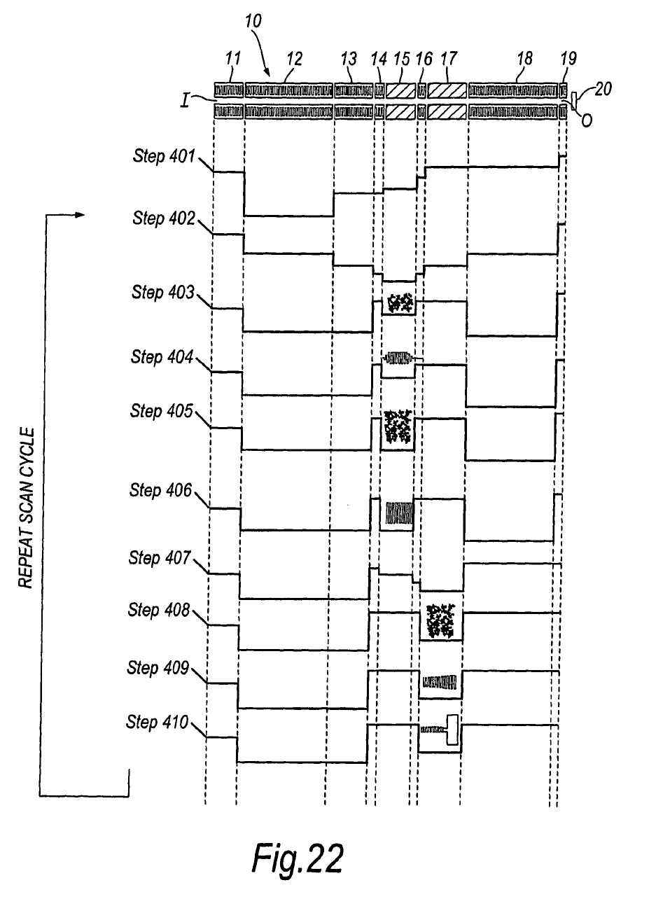

FIG. 22 shows a fourth mode of operation of the device. This mode of operation is an MS/MS mode similar to the third mode of operation described with respect to FIG. 14, but this mode also allows ions to be trapped in segments 2 and 3, whilst ions are accumulated and/or processed in segments 15-18.

The DC voltages applied in step 401 are similar to the voltages applied in step 201 of FIG. 13, and allows ions to be initially confined in segments 12 to 16, and subsequently to accumulate in the segment of lowest axial DC potential, due to loss of kinetic energy through collision with buffer gas. In this step the segment of lowest axial potential is segment 12.

The DC voltages applied in step 402 are similar to the voltages applied in step 202 of FIG. 13. The applied voltages allow the ions accumulated in segment 12 during step 401 to be transferred to segments 13-18 whilst continuing to allow new sample ions entering the device 10 to be trapped in segment 12. The ions in segments 13 to 18 lose kinetic energy through collision with buffer gas and eventually are trapped in the segment of lowest axial potential, segment 15.

In step 403 the applied voltages continue to trap ions entering device 10 in segments 12 and 13 (since these segments are at the same axial potential), whilst causing the ions in segment 15 to be axially confined within the central portion of the segment. Eventually the axially confined ions in segment 15 will reach thermal equilibrium with the buffer gas.

In step 404 the applied voltages are effective to continue to allow sample ions to enter device 10 and be stored in segments 12 and 13, whilst providing broadband isolation of the ions in segment 15 to isolate precursor ions in a desired m/z range. This precursor isolation process was described above with reference to FIGS. 15 and 16.

In step 405 the applied voltages are effective to continue to allow sample ions to enter device 10 and be stored in segments 12 and 13, whilst also cooling the isolated precursor ions in segment 15. Eventually the precursor ions will be sufficiently cooled (through collisions) to be in thermal equilibrium with the buffer gas.

In step 406, the voltages allow ions to continue to enter device 10 and be trapped in segments 12 and 13. The voltage applied to segment 15 includes a single frequency dipole excitation (as described above). This causes the precursor ions to oscillate with an amplitude and for a duration that causes CID. The fragmented ions produced by the dissociation are then trapped in segment 15.

At this stage, steps 403 to 406 may be repeated (one or more times) to provide an MSⁿ capability.

In step 407 the voltages on segments 11, 12 and 13 allow ions to continue to enter the device and be trapped in segments 12 and 13. The voltages on the remaining segments transfer ions from segment 15 into segments 15-17. The ions in segments 15-17 will lose kinetic energy through collision with the buffer gas and will eventually accumulate in the region of lowest axial DC potential, in this case in segment 17.

In step 408 the applied voltages allow ions to continue to enter device 10 and be trapped in segments 12 and 13, whilst causing ions in segment 17 to be axially confined within the central portion of segment 17. Eventually the axially confined ions will reach thermal equilibrium with the buffer gas. This step is very similar to step 403, the only difference is in the segment where the ions to be analysed are stored.

In step 409 the applied voltages allow ions to continue to enter device 10 and be trapped in segments 12 and 13. The applied voltages are also effective to compress the fragmented ions in segment 17 in an extraction direction using the burst compression technique as described above.

In step 410 the applied voltage allows ions to continue to enter device 10 and be trapped in segments 12 and 13, and cooled ions in segment 17 to be extracted for analysis in a Time-of-Flight Analyser.

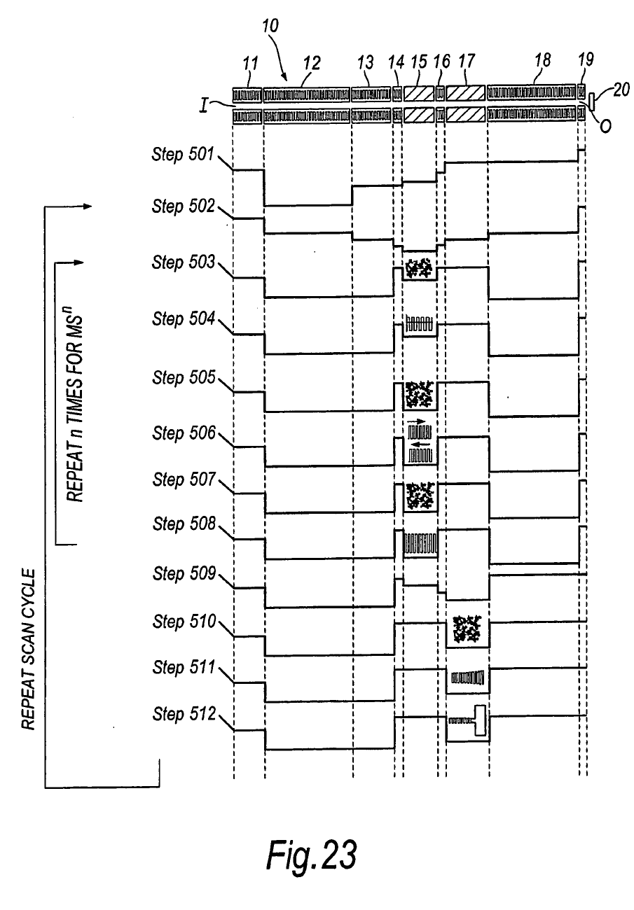

FIG. 23 shows a fifth mode of operation of the device.

This mode of operation provides precursor ion isolation with a 100% duty cycle and gives high resolving power with high efficiency. However, it is a relatively slow and is limited to 5 -10 MS/second.

In steps 501, 502 and 503 the applied voltages correspond to the voltages applied in steps 401, 402 and 403 respectively of FIG. 22 described above.

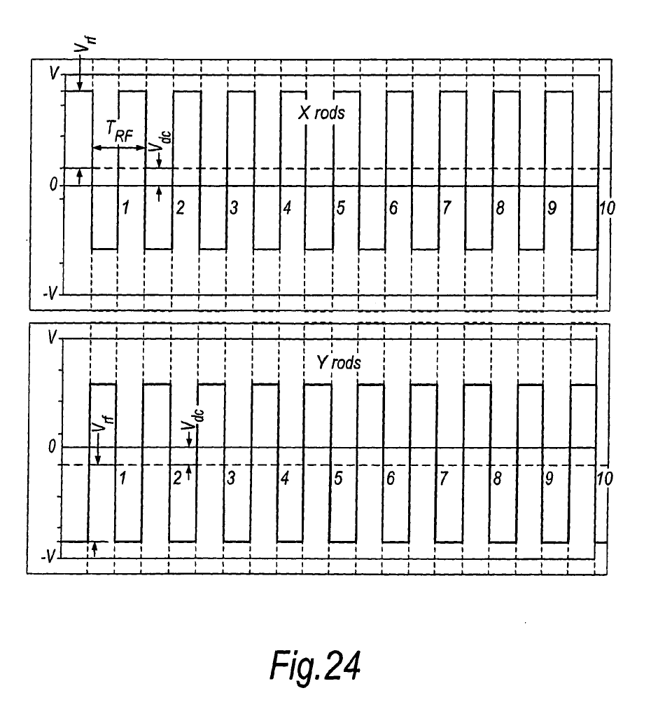

In step 504 the applied voltages are effective to continue to allow sample ions to enter device 10 and be stored in segments 12 and 13, whilst providing a voltage to segment 15 effective to isolate ions of a particular m/z range in segment 15. This isolation voltage will be described in more detail below with reference to FIGS. 24-26. The isolation voltage is effective to isolate precursor ions in a desired m/z ratio in segment 15, whilst ejecting all other ions from segment 15.

In step 505 the applied voltage corresponds to the voltage applied in step 405 of FIG. 22 described above.

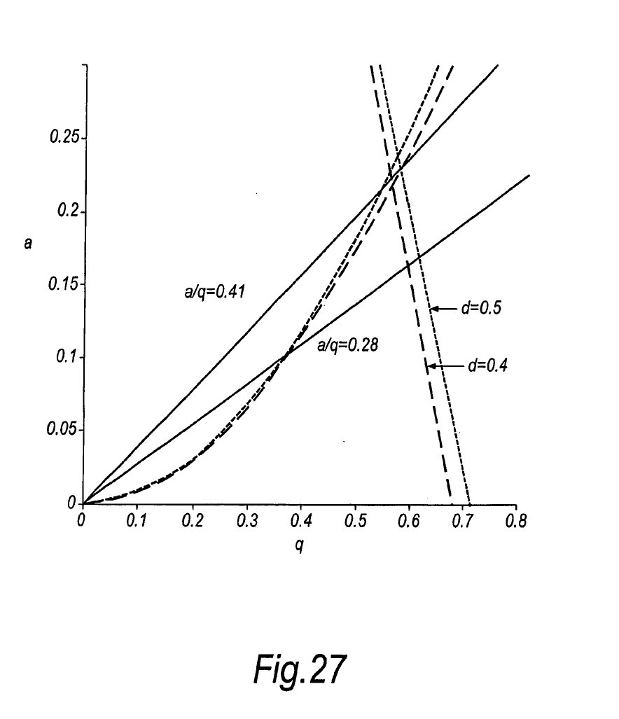

In step 506 the applied voltages are effective to continue to allow sample ions to enter device 10 and be stored in segments 12 and 13, whilst applying a frequency scan of a single frequency dipole excitation and trapping voltage to segment 15 to scan up to a desired m/z value at the lower limit of a selected range (ejecting ions below this value), then scanning in the reverse direction to eject ions above the desired m/z range, thus providing precursor isolation in a desired m/z range. This frequency scan procedure will be described in more detail below with reference to FIG. 27.

In steps 507-512 the applied voltages correspond to and have the same effect as the voltages applied in steps 405-410 respectively of FIG. 22 described above.

FIG. 24 shows a typical waveform that maybe applied to the X and Y rods of segment 15 of device 10 to allow isolation of sample ions within a particular m/z ratio within segment 15, in step 504 of the fifth mode of operation described above. Like the waveform shown in FIG. 9, a DC offset voltage is applied together with the RF trapping waveform. However, in this case, the applied DC offset is positive on the X rods, and negative on the Y rods, whereas in FIG. 9 a positive DC offset was applied to the X and Y rods. Typically, the DC offset waveform of FIG. 24 is applied using a switching circuit like that shown in FIG. 7, although other types of switching arrangement may, of course, be used to provide the waveform.

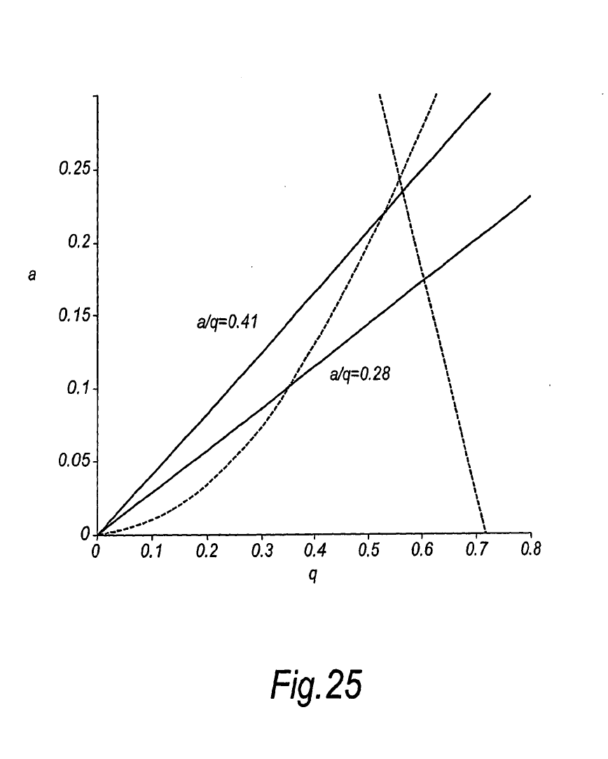

Using the waveform of FIG. 24, ions in a particular m/z range can be isolated within segment 15. How this can be achieved is illustrated with reference to FIG. 25. The magnitude of the applied DC offset voltage determines the slope of the scan line and thus the point of intersections with the boundaries of the a-q diagram. Scan lines of a/q=0.41 and a/q=0.28 are shown in the example of FIG. 25. Selecting the magnitude of the applied DC voltage (and hence the value of a/q) allows the resolving power of the to segment to be determined.

Ions in segment 15 within a desired m/z range can be isolated using the DC offset voltage in the following two ways. Firstly, the applied DC voltage is such as to move ions in the desired m/z range to the tip of the a-q stability diagram (i.e in the area bounded by the stability boundaries and above the line a/q=0.41). All other unwanted ions now reside outside the stability region and are lost from segment 15, e.g. by ejection or collision with the rods.

Alternatively, the applied DC voltage moves ions to the region of the a-q diagram bounded by the stability boundaries and above the line a/q=0.28. The RF trapping waveform can then be scanned to lower and higher frequencies to isolate ions in the desired m/z range.

The waveform of FIG. 24 may also be used for mass filtering of ions, where the ions have not yet become trapped within a segment of device 10, but are travelling through a particular segment of the device. When the waveform is applied to produce filtering, only ions at the tip of the a-q stability diagram will pass through the segment, the remaining ions are unstable and will not pass into the adjacent segment. The m/z range of the ions that are able to pass out of the filtering segment is determined by the inclination of the scan line in the a-q diagram. Unlike a conventional quadrupole mass filter the value of the applied DC voltage is independent of the desired m/z range. The desired m/z range is selected according to the frequency for a given RF amplitude.

In step 504 of FIG. 23 the ions that are isolated in segment 15 using the DC offset waveform are retained within segment 15. This is because the voltages applied to segments 14 and 16 on either side of segment 15 are higher (see FIG. 23) and so the isolated ions remain in segment 15, as this is at a lower axial potential than the adjacent segments. Of course, if the applied DC voltage on an adjacent segment is lower than the voltage on the segment where the isolation/filtering has occurred, then the isolated ions can pass out of the segment where they were isolated, into the adjacent segment, and also enter further adjacent segments if the applied voltages are such that the ions will tend to migrate to the segment of lowest axial potential.

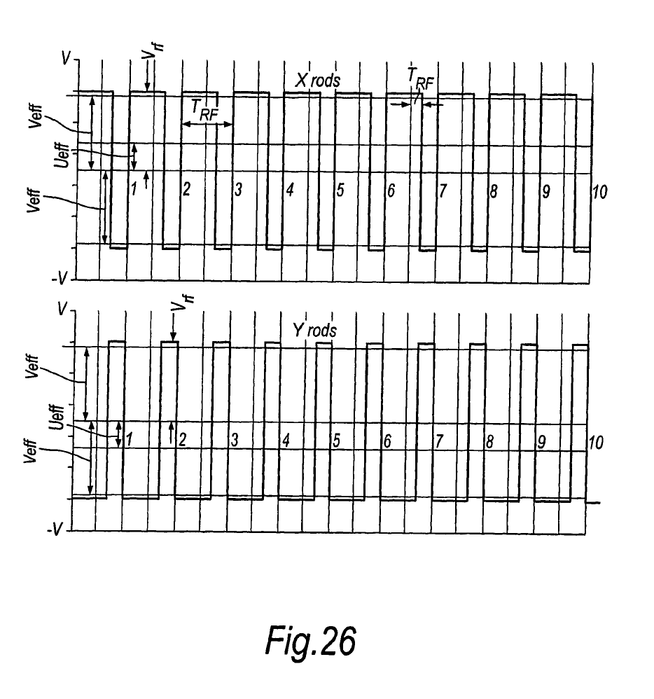

There is also an alternative way to introduce a DC offset, rather than using separate DC power supplies as discussed above. This alternative method uses modification of the duty cycle to introduce an effective DC offset between the X and Y rods. A waveform with such a modified. duty cycle is shown in FIG. 26. The effective values of the RF and DC components Veff and Ueff respectively are given by.

$$\begin{matrix}Veff ( v , d ) = 4 v ( 1 - d ) d & ( 11 ) \\ Ueff ( v , d ) = V ( 2 d - 1 ) & ( 12 ) \\ d ( T , Δ Tdc ) = 0.5 + \frac{Δ Tdc}{T} & ( 13 )\end{matrix}$$

If this duty cycle method is used to isolate/filter ions it also has an additional effect on the a-q stability diagram. This is illustrated in FIG. 27. As this Figure shows, as the duty cycle of the periodic trapping waveform is changed, the boundaries of the stability region are shifted. Whilst the duty cycle modification method is relatively easy to implement the additional effects caused by the shift in stability boundaries must be taken into consideration.

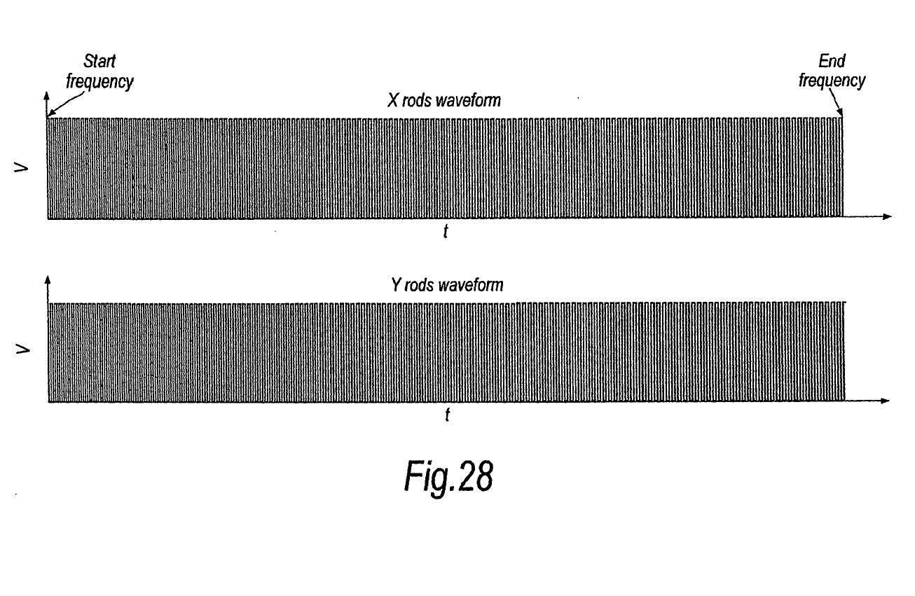

FIG. 28 illustrates the waveforms applied to the X and Y rods of segment 15 during step 506 described above (isolation by forward and reverse frequency scans). As shown in the Figure, the frequency of the RF trapping waveform is scanned, from an initial period T_{start-RF}, and is incremented by a constant amount ΔT_{RF}, after a fixed number of RF cycles, N_{wave}, until the final period T_{end-RF} is reached. In FIG. 28, T_{start-RF} is 1.29 μs and T_{end-RF} is 1.82 μs. In this case, the waveform was calculated for 5 steps with N_{wave}=23. If the waveform amplitude is 500V this will scan the m/z range for 500 Thompsons (Th) to 1000 Thompsons.

Forward and reverse m/z scans can be carried out using this type of waveform to isolate ions in a narrow m/z range, for example, 0.1 Thompsons.

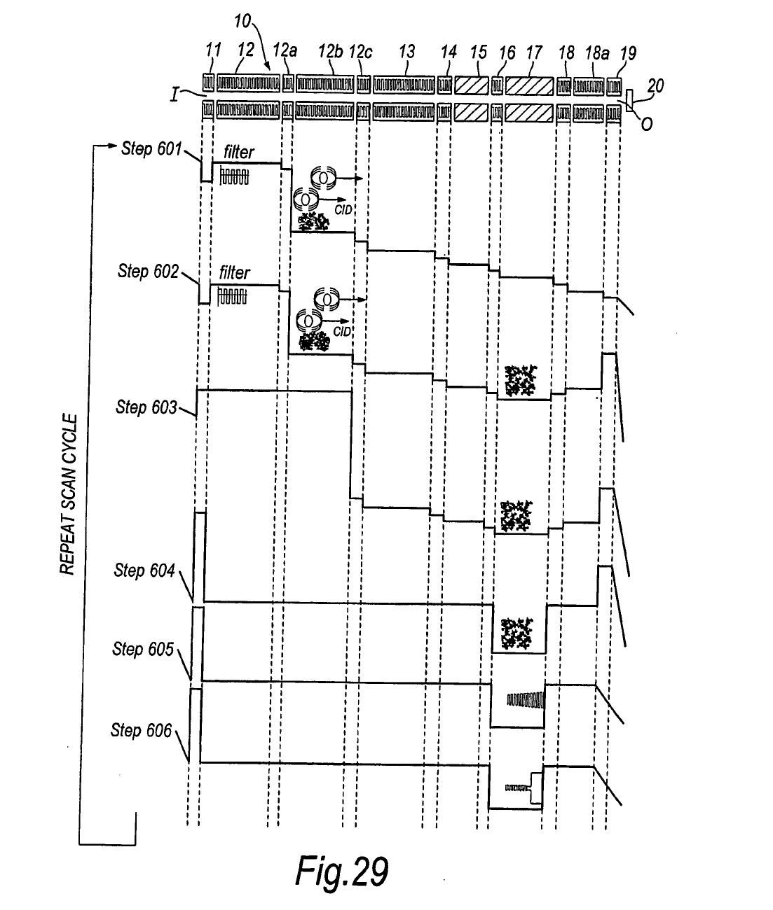

FIG. 29 shows a sixth mode of operation of the device 10. This mode of operation uses the embodiment of device 10 as shown in FIG. 3, with 13 segments. The mode is effective to provide mass selective filtering of the ions as they enter the device 10 and then fragmentation (by CID) of the filtered ions in a further segment of the device. This method provides tandem in space analysis and allows a high number of MS/MS spectra to be acquired per second, typically 50-100 spectra/sec is possible. This method also allows for automatic charge control (similar to that described with reference to the first mode as illustrated in FIG. 4).

In step 601 the applied voltages allow ions to enter device 10. The ions are filtered in segment 12 (filtering as described above) and only precursor ions within a pre-selected m/z range pass out of segment 12, to be accelerated into segment 12b which has a lower axial potential. The voltage on segment 12b is effective to cause the precursor ions to collide with buffer gas and undergo the CID process described above. Fragment ions are generated as a result of the CID process. The voltages applied to segments 12c-19 provide a stepping down of axial potential across segments 12c-19. This allows the fragmented ions exiting segment 12b to pass through segments 12c-19 to be detected by device 20 after they exit segment 19.

In step 602 the voltage applied to segments 11 and 12 is effective to allow ions into device 10 and to filter the ions in segment 12. Only ions within a preselected m/z range pass out of segment 12 into segment 12b, which has a lower axial potential. Again the voltage at segment 12b is effective to cause CID of the preselected filtered ions in segment 12b. The voltages on segments 13-18 are such as to allow ions leaving segment 12b to be trapped in segments 13-19. The precise duration of step 602 is determined according to the ion current detected by the detector 20 in step 601. (This is similar to the process as described with reference to steps 102-103 of the first mode of operation).

In step 603 the applied voltages are effective to prevent any further sample ions entering the device 10 and to allow the fragmented ions in segments 13-18a to collide with buffer gas in these segments, to lose kinetic energy and eventually to accumulate in the segment of lowest axial DC potential, in this case, in segment 17. Eventually the ions trapped in segment 17 will reach thermal equilibrium with the buffer gas.

In step 604 the applied voltages are effective to prevent further sample ions entering device 10, whilst causing fragmented ions in segment 17 to be axially confined within the. central region of segment 17.

In step 605 the applied voltages are effective to prevent further sample ions entering device 10, whilst compressing the fragmented ions in segment 17 in an extraction direction using the burst compression technique described above.

In step 606 the applied voltages prevent further sample ions entering device 10 and allow the cooled ions in segment 17 to be extracted from segment 17 for analysis in a Time-of-Flight Analyser.

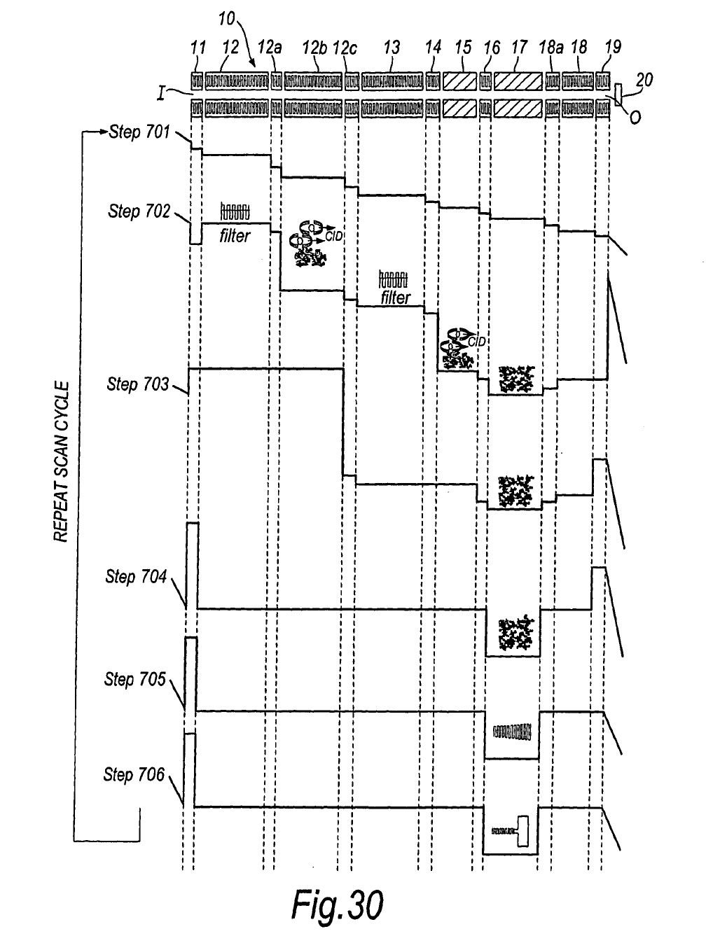

FIG. 30 shows a seventh mode of operation of device 10. Like the sixth mode described above, this mode also uses the 13 segment device as shown in FIG. 3. This mode provides MS³ analysis by having two precursor ion selection steps as well as CID fragmentation after each filtering step. This is also a ‘tandem-in space’ analysis method and allows MS³ analysis at a rate of 50-100 MS³ spectra/second, this does not require any reduction in scan rate. Like the sixth mode, this mode also allows for automatic change control.

In step 701 the applied voltages are effective to allow ions entering device 10 to pass from segment 11 to segment 19 (as each segment has a lower axial potential than the preceding segment). Ions exiting segment 19 are detected by detector 20 at the end of device 10.

In step 702 the voltages applied to segments 11 and 12 are effective to allow ions into device 10 and to filter the admitted ions in segment 12. Only ions within a preselected m/z range pass out of segment 12 into segment 12b, which has a lower axial potential. The voltage on segment 12b is effective to cause CID of the ions in segment 12b, generating MS² ions. The applied voltages cause the fragmented (MS²) ions to pass out of segment 12b into segment 13. The voltage on segment 13 is effective to filter ions entering this segment. Only ions in a preselected m/z range pass out of segment 13. The filtered ions pass out of segment 13 and into segment 15, which has a lower axial potential. The voltage on segment 15 is effective to cause CID of the ions entering this segment, resulting in the formation of MS³ ions. The MS³ ions so formed are then trapped in segments 15-18a.

In step 703 the applied voltages prevent further ions entering device 10 and allow the MS³ ions in segments 13-18a to collide with buffer gas within these segments, and lose kinetic energy and eventually accumulate in the segment of lowest axial DC potential. In this case, in segment 17. Eventually the MS³ ions trapped in segment 17 will reach thermal equilibrium with the buffer gas.

The voltages applied in steps 704-706 correspond to, and have the same effect as the voltages applied in steps 604-606 respectively, of the sixth mode, illustrated in FIG. 28 and described above.

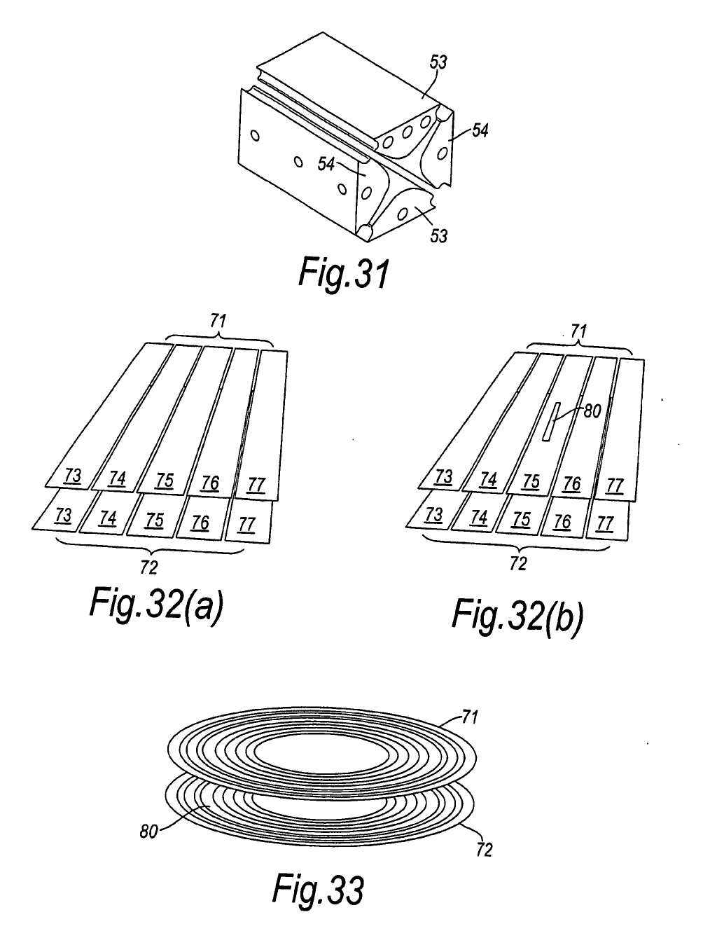

In all of the seven modes of operation described above the segmented device 10 is preferably a segmented quadrupole device. Such a segment with hyperbolically shaped rods is shown in FIG. 31. The segment has hyperbolically shaped X and Y rods 53 and 54. The X and Y rods are electrodes and they are typically made from a conductive material by precision grinding for example. Alternatively, the electrodes can be formed of electrically insulating material such as ceramic or glass, preferably zero expansion glass with an electrically conductive coating applied to the surface. Achieving the precise alignment required for the segment makes the segment relatively expensive to produce.

The hyperbolically shaped electrodes have surfaces described by the positive and negative roots of the following equations:

y(x)=\sqrt{rₒ²+x²} (14)

y(x)=\sqrt{x²−rₒ²} (15)

where rₒ is the radial dimension of the segment

The quadruple potential within the segment is then given by

$$Ø ( x , y ) = \frac{Vo}{2} \frac{{x}^{2} - {y}^{2}}{{r}_{o}^{2}} \qquad ( 16 )$$

In the normal course of operation of the modes described above, ions may pass between adjacent segments a number of times, and it is desirable to minimise any potential loss of ions as they pass between segments. If the field is not uniform between and across adjacent segments then ions maybe lost in the vicinity of the fringe field (the field in the gap between adjacent segments) as they pass between segments. This is because if the fringe field differs from the quadrupole field within the segments, the axial kinetic energy provided to transfer ions between segments will be transferred into radial kinetic energy of the ions and this will result in ion loss. To prevent this ion loss it is preferable to construct device 10 in a certain way. If the device 10 is made up entirely of segments as illustrated in FIG. 31, the quadrupole field along the entire device will be substantially uniform (and the fringe fields minimised) if rₒ for each segment is substantially the same. Alternatively, if rₒ is not the same, then the voltage on each segment can be adjusted so that the field between and across adjacent segments is substantially uniform. Again, this will minimise ion loss as ions pass between segments.

Of course, this type of device will be relatively expensive to produce due to the requirement for precise alignment. Alternatively, it is possible to construct one or more segments of device 10 using flat plate electrodes.

Such a segment can be designed and operated so that the field within the segment is substantially quadrupole field and that the field is substantially uniform between adjacent segments, where one or both of the adjacent segments is formed from plate electrodes.

Ding et al (WO 2005/119737) describe an arrangement of 4 conductive surfaces arranged as a square that can be operated to provide a substantially quadrupole field within the square.

Using plate electrodes is preferable because it is easier and less expensive to manufacture precise flat substrates as compared to manufacturing hyperbolically shaped electrodes. The insulating substrate may be a printed circuit board formed on precision ceramics or glass, preferably with a low coefficient of thermal expansion, upon which a metal coating can be applied with an underwired electrical connection made to each electrode ‘printed’ in this manner.

For example, FIGS. 32(a) and (b) show such a segment formed using plates 71 and 72. In each plate has five 10 mm wide electrodes 73-77. Typically, to substantially reproduce a quadrupole field generated by a segment constructed as in FIG. 31 with rₒ=5 mm, the separation between the plates should be 10 mm. To achieve the same field strength as in the segment of FIG. 31, the highest applied voltage is 5.6× greater than the voltage applied to the segment of FIG. 31. The actual potential within plates 71, 72 contains other (higher and/or lower order) components as well as a quadrupole component. However the voltages applied to the plate electrodes 73-77 can be controlled to minimise the non-quadrupole components, and in this way the field within the plate is substantially quadrupole and will be sufficiently matched to the field in adjacent segments to minimise ion loss as ions pass between adjacent segments.

In FIG. 32(b) there is a slit 80 in the uppermost electrode 75 of plate 71. This is an extraction slit, for when the plates 71, 72 are used as an extraction segment 15 in device 10.

The control circuitry for the plate electrodes 73-77 to provide the DC waveform and RF trapping waveform may be located on the same substrate as the electrodes 73-77. This part of the substrate can be produced by traditional printed circuit board methods, and may be located outside the vacuum region where the electrodes are located, with a vacuum seal formed around the substrate, using vacuum compatible epoxy resin for example. Alternatively, the control circuitry may be provided separately and connected to the plate electrode using flexible PCBs, with a vacuum seal formed around the PCBs.

The use of flat plates in segments of device 10 has the additional advantage that complex electrode patterns may be readily formed on the plate. For example, FIG. 33 shows a circular pair of plates 71, 72 where the electrodes are formed as a series of concentric circles on the plates. In lower plate 72 there is an extraction slot 80, through which ions can be extracted from the segment for mass analysis.

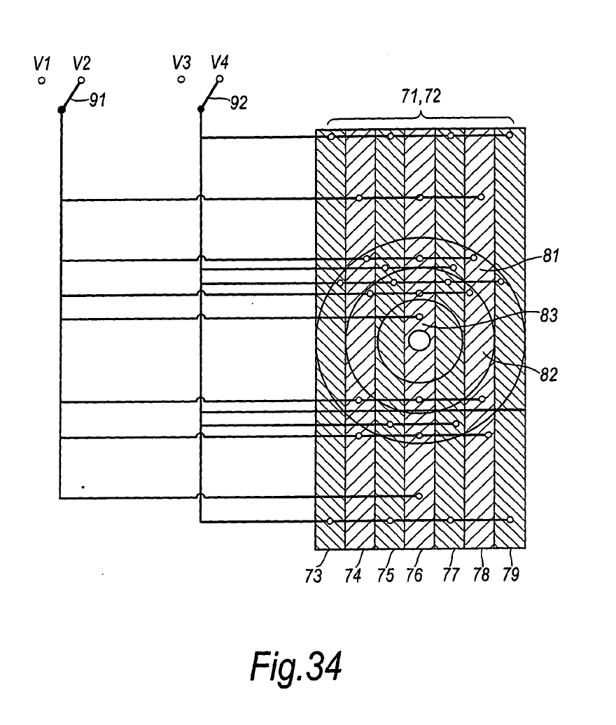

This arrangement of the electrodes can be used to form an ion cloud within the segment in the form of a toroid. By forming the ion cloud into a toroid the emittance of the cloud is generally reduced, and so this type of electrode arrangement is useful in a segment acting as an ion trap providing ions to a ToF analyser. However, there is a drawback to using this type of electrode arrangement. The drawback is that ions cannot be efficiently introduced into a segment only having this electrode configuration from an external ion source. This drawback can be overcome by using plates with an electrode configuration as shown in FIG. 34.

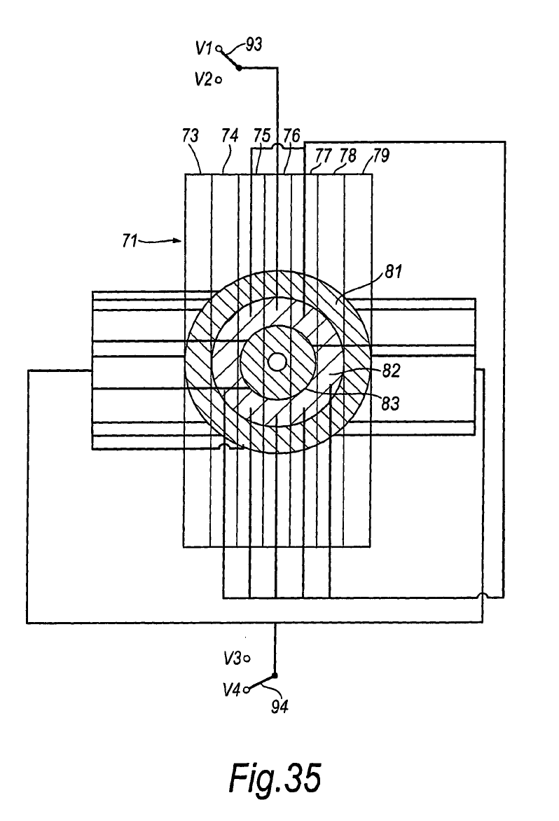

In this embodiment, the PCB plate has electrodes that allow linear trapping as well as electrodes that allow toroidal trapping. Electrodes 73-79 are the linear electrodes and electrodes 81-83 are the circular electrodes. The various connections of switches 91, 92 to the electrodes to operate in linear are also illustrated in this figure. The switches to operate in the toroidal mode are switches 93, 94 as shown in FIG. 35. Fast switching between the toroidal/linear modes of FIGS. 34 and 35 can be achieved using the method described in Ding et al; WO 01/29875.

Ions are admitted into a segment formed from the plates 71, 72 and, by controlling the voltage on the linear electrodes the ion cloud is assembled along the longitudinal axis of the segment (as a substantially 1D ion cloud). As discussed above, ions can be efficiently introduced into a segment with this electrode configuration from an external ion source. The linear electrodes 73-79 are then switched off and the circular electrodes 81-83 switched on. This will cause the ion cloud to be transformed from a substantially 1D axially extending cloud to a substantially 2D ion cloud. In this particular case, the circular electrodes 81-83 form the 2D ion cloud in a toroidal shape. Of course, electrodes 81-83 may be formed in alternative 2D arrangements to produce ion clouds of alternative 2D shape.

The toroidally shaped ion cloud has the same charge capacity as the longitudinal ion cloud but will occupy a region of space approximately π× smaller than the longitudinal ion cloud. This will reduce the emittance of the ion cloud.

The diameter of the circular electrodes 81-83 determines the diameter of the toroidal ion cloud that will be produced. For examples, to produce a toroidally shaped ion cloud 5 mm in diameter the width of the circular electrodes should be 2.5 mm and the separation between plates 71 and 72 should be approximately 2.5 mm. After the toroidally shaped cloud is formed an extraction voltage can be applied to extract ions for analysis through exit slot 80. The above mentioned ‘delay’ and/or “burst compression” techniques may be used before the extraction voltage is applied, and before and/or after the 2D ion cloud is formed.

The extraction voltage that will be applied to a segment with this particular plate/electrode configuration is 4 times less than the extraction voltage that would have to be applied to a segment formed with hyperbolic electrodes and rₒ=5 mm. This is clearly a desirable reduction and so it is preferable to use a segment formed from plates 71, 72 as an extraction segment 15.

1-102. (canceled)

103. A time-of-flight mass spectrometer comprising:
an ion source for supplying sample ions;
a segmented linear ion storage device having a longitudinal axis, for receiving sample ions supplied by the ion source;
voltage supply means for supplying to the device:
(i) a trapping voltage which, with the assistance of cooling gas, is effective to trap sample ions, or ions derived from said sample ions in an axially-extending region of the device, said axially-extending region comprising a trapping volume of a group of two or more mutually adjacent segments of the device and to cause ions trapped in said axially-extending region subsequently to become trapped in an extraction region of said axially-extending region to form an ion cloud, said extraction region being shorter than said axially-extending region, and
(ii) an extraction voltage for causing ejection of the ion cloud from said extraction region in an extraction direction orthogonal to said longitudinal axis of the device, and a time-of-flight mass analyzer for performing mass analysis of ions ejected from said extraction region.

104. A spectrometer as claimed in claim 103 wherein said voltage supply means is arranged to supply RF trapping voltage to said device to create a quadrupole trapping field which is substantially uniform along and between adjacent segments of said device, to enable ions to pass between adjacent segments without substantial loss of ions.

105. A spectrometer as claimed in claim 104 wherein adjacent segments of said segmented device have substantially the same radial dimension.

106. A spectrometer as claimed in claim 103 wherein said extraction region comprises a trapping volume of a single segment of the device.

107. A spectrometer as claimed in claim 103 wherein the radial dimension of each segment of said segmented device is substantially the same.

108. A spectrometer as claimed in claim 103 further comprising ion cloud treatment means for reducing the physical size of, and/or velocity spread of ions in said ion cloud in directions transverse to said longitudinal axis before said extraction voltage is applied.

109. A spectrometer as claimed in claim 108 wherein said ion cloud treatment means is effective to encourage said ion cloud to form on said longitudinal axis before said extraction voltage is applied.

110. A spectrometer as claimed in claim 108 wherein said extraction region comprises a trapping volume of one or more extraction segment of the device and said ion cloud treatment means is arranged to cause said voltage supply means to increase a trapping voltage applied to said extraction region.

111. A spectrometer as claimed in claim 110 wherein said increase comprises a succession of stepped abrupt increases.

112. A spectrometer as claimed in claim 108 wherein said extraction region comprises a trapping volume of one or more extraction segment of the device and said ion cloud treatment means is arranged to cause said voltage supply means to terminate a trapping voltage applied to said extraction segment(s) and to impose a delay between termination of the trapping voltage and application of the extraction voltage.

113. A spectrometer as claimed in claim 112 wherein said voltage supply means applies an intermediate voltage to said extraction segment(s) during said delay.

114. A spectrometer as claimed in claim 108 wherein said trapping voltage is also effective to compress said ion cloud axially within said extraction region.

115. A spectrometer as claimed in claim 106 wherein said extraction region comprises a trapping volume of an extraction segment of the device, and wherein said extraction segment includes first electrode means which, when supplied with a first said trapping voltage enables ions to form a substantially one-dimensional axially extending ion cloud within the extraction region and second electrode means which, when supplied with a second said trapping voltage is effective to transform said substantially one-dimensional axially extending cloud to form a substantially two-dimensional ion cloud in a central plane orthogonal to said extraction direction.

116. A spectrometer as claimed in claim 115 wherein said substantially two-dimensional ion cloud is a toroidally shaped ion cloud.

117. A spectrometer as claimed in claim 115 comprising ion cloud treatment means for reducing the physical size of, and/or velocity spread of ions in the ion cloud in directions transverse to said longitudinal axis before and/or after said second trapping voltage is applied.

118. A spectrometer as claimed in claim 103 wherein said device has an entrance end and an exit end, ion detection means located at said exit end, and said voltage supply means is arranged to allow sample ions to pass through said device from said entrance end to said exit end for detection by said ion detection means and subsequently to trap ions received within the device from said ion source and prevent further ions from entering the device after a time interval determined by an ion current detected by said ion detection means.

119. A spectrometer as claimed in claim 103 wherein said trapping voltage is effective to trap sample ions in an ion storage region of the device located between an entrance end of the device and an axially-extending region of the device and subsequently to cause ions to pass from said ion storage region into another region of the device whilst simultaneously trapping further sample ions in the ion storage region.

120. A spectrometer as claimed in claim 119 wherein said ion storage region comprises a trapping volume of a single segment of the device.

121. A spectrometer as claimed in claim 119 wherein said another region is said axially extending region.

122. A spectrometer as claimed in claim 119 wherein voltage supplied to said device by said voltage supply means causes ions to undergo fragmentation and/or isolation in a region or regions outside said ion storage region whilst simultaneously trapping further sample ions in said ion storage region.

123. A spectrometer as claimed in claim 103 wherein said trapping voltage is effective to trap ions in a fragmentation region of the device, and said voltage supply means is arranged to supply fragmentation voltage to the device to cause fragmentation of ions trapped in the fragmentation region.

124. A spectrometer as claimed in claim 123 wherein said fragmentation voltage comprises dipole excitation voltage effective to cause fragmentation of ions in a selected range of mass-to-charge ratio.

125. A spectrometer as claimed in claim 124 wherein said dipole excitation voltage is effective to cause said fragmentation of ions by Collision Induced Dissociation (CID).

126. A spectrometer as claimed in claim 125 wherein said dipole excitation voltage is effective to cause CID by accelerating ions from one or more segment(s) of said device into an adjacent segment or segments at lower axial potential.

127. A spectrometer as claimed in claim 123 wherein said fragmentation region is separate from said extraction region and said fragmentation voltage creates a quadrupole trapping field substantially within the entire volume of said fragmentation region.

128. A spectrometer as claimed in claim 123 wherein said voltage supply means is arranged to supply isolation voltage to the device to isolate for fragmentation precursor ions in a selected range of mass-to-charge ratio.

129. A spectrometer as claimed in claim 128 wherein said isolation voltage is broadband isolation voltage effective to isolate precursor ions in said selected range of mass-to-charge ratio.

130. A spectrometer as claimed in claim 128 wherein said isolation voltage is effective to perform forward and reverse frequency scanning to eject ions to either side of said selected range of mass-to-charge ratio.

131. A spectrometer as claimed in claim 128 wherein said isolation voltage is applied to segment(s) of said device separate from said extraction region, and creates a quadrupole trapping field along substantially within the entire volume of the segment(s) to which it is applied.

132. A spectrometer as claimed in claim 121 wherein said voltage supply means is arranged to cause mass to charge ratio filtering of ions prior to fragmentation and/or isolation of the ions.

133. A spectrometer as claimed in claim 121 wherein said voltage supply means is arranged to cause filtering of ions in a first filtering region of the device prior to their fragmentation and to cause further filtering of ions in a second filtering region of the device after their fragmentation.

134. A spectrometer as claimed in claim 133 wherein said first filtering region and said second filtering region are each defined by a single segment of the device.

135. A spectrometer as claimed in claim 133 wherein said fragmentation voltage is effective to cause further fragmentation of ions before they become trapped in said axially extending region.

136. A spectrometer as claimed in claim 133 wherein filtering and fragmentation are carried out simultaneously in the respective regions of the device.

137. A spectrometer as claimed in claim 123 wherein said fragmentation voltage is effective to cause repeated fragmentation of ions to provide a MSⁿ capability.

138. A spectrometer as claimed in claim 103 wherein said voltage supply means is arranged to cause filtering of ions before they become trapped in said axially-extending region of the device.

139. A mass spectrometer according to claim 103 wherein said segmented device is a segmented linear quadrupole ion storage device.

140. A spectrometer as claimed in claim 103 wherein said trapping voltage includes a digitally-controlled rectangular waveform voltage.

141. A mass spectrometer as claimed in claim 139 wherein at least one segment of the device is constructed from flat plate electrodes.

142. A segmented linear ion storage device for use in a time-of-flight mass spectrometer as claimed in claim 103.

143. A time-of-flight mass spectrometer comprising:
an ion source for supplying sample ions;
a segmented linear multipole ion storage device having a longitudinal axis for receiving sample ions supplied by the ion source;
voltage supply means for supplying to the device;
(i) an RF trapping voltage to create a multipole trapping field which is substantially uniform along and between adjacent segments of said device, to enable ions to pass between adjacent segments without substantial loss of ions.
(ii) a DC trapping voltage, which, with the assistance of cooling gas, is effective to trap sample ions, or ions derived from sample ions in an extraction region of said device to form an ion cloud, and
(iii) an extraction voltage for causing ejection of the ion cloud from said extraction region in an extraction direction orthogonal to said longitudinal axis of said device, and
a time-of-flight mass analyzer for performing mass analysis of ions ejected from said extraction region.

144. A spectrometer as claimed in claim 143 wherein said extraction region comprises a trapping volume of a single segment of the device.

145. A spectrometer as claimed in claim 143 wherein the radial dimension of each segment of said segmented device is substantially the same.

146. A spectrometer as claimed in claim 143 further comprising ion cloud treatment means for reducing the physical size of, and/or velocity spread of ions in said ion cloud in directions transverse to said longitudinal axis before said extraction voltage is applied.

147. A spectrometer as claimed in claim 146 wherein said ion cloud treatment means is effective to encourage said ion cloud to form on said longitudinal axis before said extraction voltage is applied.

148. A spectrometer as claimed in claim 146 wherein said extraction region comprises a trapping volume of one or more extraction segment of the device and said ion cloud treatment means is arranged to cause said voltage supply means to increase a trapping voltage applied to said extraction region.

149. A spectrometer as claimed in claim 148 wherein said increase comprises a succession of stepped abrupt increases.

150. A spectrometer as claimed in claim 146 wherein said extraction region comprises a trapping volume of one or more extraction segment of the device and said ion cloud treatment means is arranged to cause said voltage supply means to terminate a trapping voltage applied to said extraction segment(s) and to impose a delay between termination of the trapping voltage and application of the extraction voltage.

151. A spectrometer as claimed in claim 150 wherein said voltage supply means applies an intermediate voltage to said extraction segment(s) during said delay.

152. A spectrometer as claimed in claim 146 wherein said trapping voltage is also effective to compress said ion cloud axially within said extraction region.

153. A spectrometer as claimed in claim 144 wherein said extraction region comprises a trapping volume of an extraction segment of the device, and wherein said extraction segment includes first electrode means which, when supplied with a first said trapping voltage enables ions to form a substantially one-dimensional axially extending ion cloud within the extraction region and second electrode means which, when supplied with a second said trapping voltage is effective to transform said substantially one-dimensional axially extending cloud to form a substantially two-dimensional ion cloud in a central plane orthogonal to said extraction direction.

154. A spectrometer as claimed in claim 153 wherein said substantially two-dimensional ion cloud is a toroidally shaped ion cloud.

155. A spectrometer as claimed in claim 153 comprising ion cloud treatment means for reducing the physical size of, and/or velocity spread of ions in the ion cloud in directions transverse to said longitudinal axis before and/or after said second trapping voltage is applied.

156. A spectrometer as claimed in claim 143 wherein said device has an entrance end and an exit end, ion detection means located at said exit end, and said voltage supply means is arranged to allow sample ions to pass through said device from said entrance end to said exit end for detection by said ion detection means and subsequently to trap ions received within the device from said ion source and prevent further ions from entering the device after a time interval determined by an ion current detected by said ion detection means.

157. A spectrometer as claimed in claim 143 wherein said trapping voltage is effective to trap sample ions in an ion storage region of the device located between an entrance end of the device and an axially-extending region of the device and subsequently to cause ions to pass from said ion storage region into another region of the device whilst simultaneously trapping further sample ions in the ion storage region.

158. A spectrometer as claimed in claim 157 wherein said trapping voltage is effective to trap sample ions in an ion storage region of the device located between an entrance end of the device and an axially-extending region of the device and subsequently to cause ions to pass from said ion storage region into another region of the device whilst simultaneously trapping further sample ions in the ion storage region.

159. A spectrometer as claimed in claim 157 wherein said ion storage region comprises a trapping volume of a single segment of the device.

160. A spectrometer as claimed in claim 157 wherein said another region is said axially extending region.

161. A spectrometer as claimed in claim 143 wherein said trapping voltage is effective to trap ions in a fragmentation region of the device, and said voltage supply means is arranged to supply fragmentation voltage to the device to cause fragmentation of ions trapped in the fragmentation region.

162. A spectrometer as claimed in claim 161 wherein said fragmentation voltage comprises dipole excitation voltage effective to cause fragmentation of ions in a selected range of mass-to-charge ratio.

163. A spectrometer as claimed in claim 162 wherein said dipole excitation voltage is effective to cause said fragmentation of ions by Collision Induced Dissociation (CID).

164. A spectrometer as claimed in claim 163 wherein said dipole excitation voltage is effective to cause CID by accelerating ions from one or more segment(s) of said device into an adjacent segment or segments at lower axial potential.

165. A spectrometer as claimed in claim 161 wherein said fragmentation region is separate from said extraction region and said fragmentation voltage creates a quadrupole trapping field substantially within the entire volume of said fragmentation region.

166. A spectrometer as claimed in claim 161 wherein said voltage supply means is arranged to supply isolation voltage to the device to isolate for fragmentation precursor ions in a selected range of mass-to-charge ratio.

167. A spectrometer as claimed in claim 166 wherein said isolation voltage is broadband isolation voltage effective to isolate precursor ions in said selected range of mass-to-charge ratio.

168. A spectrometer as claimed in claim 166 wherein said isolation voltage is effective to perform forward and reverse frequency scanning to eject ions to either side of said selected range of mass-to-charge ratio.

169. A spectrometer as claimed in claim 166 wherein said isolation voltage is applied to segment(s) of said device separate from said extraction region, and creates a quadrupole trapping field along substantially within the entire volume of the segment(s) to which it is applied.

170. A spectrometer as claimed in claim 157 wherein said voltage supply means is arranged to cause mass to charge ratio filtering of ions prior to fragmentation and/or isolation of the ions.

171. A spectrometer as claimed in claim 157 wherein said voltage supply means is arranged to cause filtering of ions in a first filtering region of the device prior to their fragmentation and to cause further filtering of ions in a second filtering region of the device after their fragmentation.

172. A spectrometer as claimed in claim 171 wherein said first filtering region and said second filtering region are each defined by a single segment of the device.

173. A spectrometer as claimed in claim 172 wherein said fragmentation voltage is effective to cause further fragmentation of ions before they become trapped in said axially extending region.

174. A spectrometer as claimed in claim 171 wherein filtering and fragmentation are carried out simultaneously in the respective regions of the device.

175. A spectrometer as claimed in claim 161 wherein said fragmentation voltage is effective to cause repeated fragmentation of ions to provide a MSⁿ capability.

176. A mass spectrometer according to claim 143 wherein said segmented device is a segmented linear quadrupole ion storage device.

177. A mass spectrometer as claimed in claim 176 wherein at least one segment of the device is constructed from flat plate electrodes.

178. A segmented linear ion storage device for use in a time-of-flight mass spectrometer as claimed in claim 143.

179. A time-of-flight mass spectrometer comprising,
an ion source for supplying sample ions,
a segmented linear ion storage device having a longitudinal axis for receiving sample ions supplied by the ion source,
voltage supply means for supplying RF multipole trapping voltage to the device,
for selectively supplying DC voltage to segments of the device to cause sample ions, or ions derived from sample ions to move between different axially-extending regions of the device where ions selectively undergo MS processing, and for causing processed ions to become trapped in the trapping volume of an extraction segment of the device, and
for supplying an extraction voltage to the extraction segment to ejected trapped ions in an extraction direction, orthogonal to said longitudinal axis of the device,
and a time-of-flight analyzer for performing mass analysis of ions ejected from the extraction segment.

180. A spectrometer as claimed in claim 179 wherein said RF multipole trapping voltage is substantially uniform along and between adjacent segments of the device to enable ions to move between adjacent segments without substantial loss of ions.

181. A spectrometer as claimed in claim 180 wherein said MS processing is selected from fragmentation, isolation, filtering and storage.

182. A time-of-flight mass spectrometer as claimed in claim 181 wherein different MS processes are simultaneously carried out in different axially-extending regions of the device.

183. A time-of-flight mass spectrometer as claimed in claim 182 wherein each axially extending region comprises a single segment or a group of two or more mutually adjacent segments.

184. A segmented linear ion storage device for use in a time-of-flight mass spectrometer as claimed in claim 179.
